(19) United States
(12) Patent Application Publication
(10) Pub. No.: US 2021/0062411 A1
(43) Pub. Date: Mar. 4, 2021

(54) CELLULOSIC FIBERS COMPRISING EMBEDDED SILVER NANOPARTICLES AND USES THEROF

(71) Applicant: The United States of America, as Represented by the Secretary of Agriculture, Washington, DC (US)

(72) Inventors: SUNGHYUN NAM, METAIRIE, LA (US); BRIAN D. CONDON, NEW ORLEANS, LA (US); MATTHEW B. HILLYER, NEW ORLEANS, LA (US)

(21) Appl. No.: 16/804,535

(22) Filed: Feb. 28, 2020

Related U.S. Application Data
(60) Provisional application No. 62/894,179, filed on Aug. 30, 2019.

(51) Int. Cl. D06M 11/83; D06M 23/08

(52) U.S. Cl. CPC D06M 11/83; D06M 11/38; D06M 23/08

(57) ABSTRACT

The present invention relates to treated cellulosic fibers comprising embedded silver nanoparticles, where the cellulosic treated fiber is not a swollen cellulosic fiber. The invention includes methods for preparing such cellulosic fibers, articles comprising such cellulosic fibers, and uses for such articles. The invention further relates to methods for preparing treated swollen cellulosic fibers comprising embedded silver nanoparticles.

### CROSS-REFERENCE TO RELATED APPLICATIONS

This application claims priority to U.S. Provisional Patent Application 62/894,179, filed Aug. 30, 2019, the content of which is expressly incorporated herein by reference in its entirety.

### FIELD OF THE INVENTION

This invention relates to cellulosic fibers comprising embedded silver nanoparticles, methods for preparation of such cellulosic fibers, and uses of such cellulosic fibers.

### BACKGROUND OF THE INVENTION

In reaction to the constantly evolving adversities of new pathogens, pressure has increased from consumer groups to develop effective and persistent antibacterial textiles. According to the report published by REPORTBUYER (an aggregator of market research studies), the antibacterial textiles market is forecasted to reach USD 1.1 billion by 2026. Due to their high surface area to volume ratio and nanomechanical attack mechanisms, silver nanoparticles have emerged as a new class of powerful, broad-spectrum antibacterial agents (Simončič, B. and Klemenčič, D., 2015, “Preparation and performance of silver as an antimicrobial agent for textiles: A review,” Text. Res. J. 86: 210-223). Nanoparticles with a high surface area are efficacious in releasing antibacterial silver ions which can penetrate and damage bacterial cells. At low concentrations, silver nanoparticles are known to be nontoxic to human cells. As a result, silver nanoparticles have widely been employed in food, healthcare, life sciences, electronics, and textile industries. Their market size was valued at over USD 1.3 billion in 2017, and textiles accounted for over 25% of the overall market.

The antimicrobial activity of silver nanoparticles is highly influenced by the dimensions of the particles—the smaller the particles, the greater the antimicrobial efficiency (Panáček A. et al., “Silver colloid nanoparticles: Synthesis, characterization, and their antibacterial activity,” J. Phys. Chem. B 110: 16248-16253). Fibers containing metallic sub-micron size particles attached to the fiber are known. These may be obtained by adding and dispersing fine metallic particles in a polymer followed by making the resulting polymer fibrous. Fibers containing fine metallic particles may also be obtained by making fine inorganic particles carrying fine metallic particles, adding these inorganic particles to a resin, and shaping the resulting resin into a fiber. U.S. Pat. No. 10,190,253 discloses the preparation of articles such as fabrics, fibers, filaments, and yarns coated with a generally even distribution of metal nanoparticles. The method disclosed comprises applying a liquid carrier and a plurality of nonionic metal nanoparticles to the article, utilizing a dry fog system to yield an article in which the nonionic metal nanoparticles are non-covalently affixed to the article.

A variety of methods are currently employed to prepare silver nanoparticles. The most common methods to produce silver nanoparticles require the use of stabilizing agents to control the growth of silver particles in aqueous or non-aqueous solvents. Generally, silver ions are reduced to silver atoms by irradiation, or by using reducing agents such as hydrazine, sodium borohydride, and N,N-dimethylformamide. Particle aggregation is prevented by using surfactants and polymers. Silver nanoparticles synthesized in the solution phase (silver colloids) are generally applied as an additive onto various natural or synthetic fabrics or yarns using the traditional textile finishing process of pad-dry (or pad-dry-cure). This bulk solution process, however, is likely to result in inhomogeneous dispersion and aggregation of the applied nanoparticles. Silver nanoparticles observed on the surface of textiles are up to two orders of magnitude larger than the pristine particles seen in the colloidal solution. Moreover, these surface-loaded particles are easily detached from the fabric during washing. For example, Limpiteeprakan P. et al (2016, “Release of Silver Nanoparticles from Fabrics During the Course of Sequential Washing,” Environ. Sci. Pollut. Res. 23: 22810-22818) tested the release of silver nanoparticles (AgNP) from fabrics with loaded AgNP prepared in the laboratory and from commercially available fabrics containing AgNP. After 20 wash cycles using only Milli Q water, AgNP-loaded fabrics prepared in the laboratory retained 28 to 52% of the silver; and AgNP-containing commercially available fabrics retained 46 to 70% of the silver. When using commercial detergent, about 15 to 33% of the silver remained in the commercially-available fabric after 10 wash cycles, and after 20 wash cycles only 6 to 16% of the silver remained on the fabrics prepared in the laboratory, and about 7 to 18% of the silver remained on the commercially-available fabric

U.S. Pat. No. 6,607,994 relates to preparations comprising “an agent or other payload surrounded by or contained within a polymeric encapsulator that is reactive to webs, to give textile-reactive nanoparticles.” This patent teaches the preparation of zeolites containing silver nanoparticles as payload. The zeolite particles are exposed to an aqueous solution of poly(ethylenimine) that has been grafted with an epoxide, resulting in the infusion of silver in porous zeolites. According to the specification of this patent, the zeolites used are from 0.6 to 2.5 micrometers (600 to 2500 nm).

PCT publication WO 2006/066488 discloses a method for attaching silver nanoparticles to yarn by immersing degreased yarn in a silver nitrate solution, rolling, and squeezing the yarn to absorb the silver nitrate solution, removing the solution containing loose silver nanoparticles by centrifugation, drying the yarn at 120° C. to 160° C. for 40 to 60 minutes, rinsing the dried yarn in water, and drying the yarn one more time. This PCT publication also discloses a method for attaching silver nanoparticles to cotton by immersing degreased cotton in a solution prepared with silver oxide, citric acid hydrate, ammonia, and water, removing the solution containing loose silver nanoparticles by centrifugation, drying at 120° C. to 160° C. for 40 to 60 minutes, washing with water, centrifuging again, and drying one last time. U.S. Pat. No. 6,979,491 discloses preparing a silver nanoparticle-containing solution by mixing silver nitrate and glucose aqueous solutions, and attaching the silver nanoparticles to yarn.

All the methods referred to above involve the external production of silver nanoparticles, which requires the use of a reducing agent (such as sizing materials applied on yarns, citric acid hydrate, or glucose), and the attachment of silver nanoparticles onto the surface of cotton. These surface-bound silver nanoparticles are easily detached from the fiber surface during use and washing. Studies have reported that up to 20% to 30% of the silver nanoparticles attached in this way are released in the first washing (Benn, T. M. and Westerhoff, P., 2008, “Nanoparticle silver released into water from commercially available sock fabrics,” Environ. Sci. Technol. 42: 4133-4139; Geranio, L., et al., “The behavior of silver nanotextiles during washing,” Environ. Sci. Technol. 43: 8113-8118; and Lorenz, C. et al., “Characterization of silver release from commercially available functional (nano)textiles,” Chemosphere 89: 817-824) and 87% of the silver nanoparticles are washed off during five simulated home laundering cycles (Lee, H. J., et al., “Antibacterial effect of nanosized silver colloidal solution on textile fabrics,” J. Mater. Sci. 38: 2199-2204).

To improve the washing durability of silver nanoparticles on textiles, there have been numerous efforts to immobilize the silver nanoparticles onto the textiles. Most of these methods rely on the use of chemical binders. Many immobilization processes require multiple reaction steps and modification of the textile surfaces to introduce electrostatic interactions or covalent bonds between the textile and the silver nanoparticles. An in situ synthetic method of producing silver nanoparticles inside the cotton fiber has been reported. This method requires swelling the fibers in a highly alkaline (sodium hydroxide) solution and using a reducing agent (Nam, S. and Condon, B., 2014, “Internally dispersed synthesis of uniform silver nanoparticles via in situ reduction of [Ag(NH₃)₂]⁺ along natural microfibrillar substructures of cotton fiber,” Cellulose 21: 2963-2972). The highly alkaline treatment irreversibly changes the internal structure of cotton fibers. When treated in this way, the crystalline structure of the cotton fiber has changed such that the orientation of the cellulose chains has been rearranged from parallel chains (cellulose Iβ) into anti-parallel chains (cellulose II). The images in FIGS. 3 and 5 of this Nam and Condon paper show that the alkaline treatment caused the fiber to swell greatly and transformed the bean-shape cross-section into a rounder shape.

Thus, a method is needed to prepare cellulosic fibers comprising embedded silver nanoparticles while eliminating the use of reducing and stabilizing agents.

### SUMMARY OF THE INVENTION

Provided herein are cellulosic fibers comprising embedded silver nanoparticles, methods for forming embedded silver nanoparticles in cellulosic fibers, and uses for such cellulosic fibers comprising embedded silver nanoparticles.

In an embodiment, the invention relates to a treated cellulosic fiber comprising embedded silver nanoparticles, where the cellulosic fiber treated is not a swollen cellulosic fiber. In some embodiments of the invention, the cellulosic fiber treated is selected from the group consisting of white cotton, sticky cotton, naturally colored cotton, scoured and bleached cotton, flax, hemp, jute, ramie, pineapple leaf, and abaca. In some embodiments of the invention, the cotton fiber treated is selected from the group consisting of white cotton, sticky cotton, naturally colored cotton, and scoured and bleached cotton. In some embodiments of the invention, the cellulosic fiber treated is raw white cotton fiber, and the silver nanoparticles are embedded mostly on the cuticle and primary wall of the treated fiber. In some embodiments of the invention, the cellulosic fiber treated is selected from the group consisting of ramie, white cotton fiber, sticky fiber, naturally colored cotton fiber, and treated scoured and bleached cotton fiber, and the silver nanoparticles are embedded throughout the inner layers of the treated fiber.

In an embodiment, the invention relates to treated cellulosic fiber comprising embedded silver nanoparticles, where at least about 50% of the silver nanoparticles remain embedded in the treated cellulosic fiber after at least about 10, 20, 30, 40, or 50 laundering cycles. In some embodiments of the invention, at least about 50% of the silver nanoparticles remain embedded in the treated cellulosic fiber after at least about 10 laundering cycles. In some embodiments of the invention, at least about 50% of the silver nanoparticles remain embedded in the treated cellulosic fiber after at least about 20 laundering cycles. In some embodiments of the invention, at least about 50% of the silver nanoparticles remain embedded in the treated cellulosic fiber after at least about 30 laundering cycles. In some embodiments of the invention, at least about 50% of the silver nanoparticles remain embedded in the treated cellulosic fiber after at least about 40 laundering cycles. In some embodiments of the invention, at least about 50% of the silver nanoparticles remain embedded in the treated cellulosic fiber after at least about 50 laundering cycles. In some embodiments of the invention, the AATCC Test Method 61-2007 washing durability test was used to determine the silver nanoparticles remaining in treated cellulosic fibers after laundering cycles.

In an embodiment, the invention relates to an article comprising at least one treated cellulosic fiber comprising embedded silver nanoparticles, where the cellulosic fiber treated is not a swollen cellulosic fiber. In some embodiments of the invention, the article comprising at least one treated cellulosic fiber comprising embedded silver nanoparticles is selected from the group consisting of a yarn, a thread, a twine, a rope, a cloth, a woven fabric, a knitted fabric, a film-based composite, a nonwoven fabric, a final article. In some embodiments, the invention relates to athletic wear, an undergarment, military wear, a medical textile, a washable sanitizing wipe, a disposable sanitizing wipe, a film-based fiber-containing composite, a functional barrier, a towel, a bedding, a shoe liner, a garment liner, or a curtain comprising at least one treated cellulosic fiber comprising embedded silver nanoparticles, where the cellulosic fiber treated is not a swollen cellulosic fiber. In some embodiments of the invention, the medical textile comprising at least one treated cellulosic fiber comprising embedded silver nanoparticles is selected from the group consisting of a curtain, a bedding, a surgical arena fabric, a surgical personnel protective garment, and a wound or non-wound patient dressing, a bandage, a gauze, a packing, or a cleaning material.

In an embodiment, the invention relates to an antimicrobial, antibacterial, anti-odor, antiviral, or anti-fungal article comprising at least one treated cellulosic fiber comprising embedded silver nanoparticles, where the cellulosic fiber treated is not a swollen cellulosic fiber. In some embodiments of the invention, the article comprising at least one treated cellulosic fiber comprising embedded silver nanoparticles, where the cellulosic fiber treated is not a swollen cellulosic fiber is used to inhibit microbes, bacteria, unpleasant odor, virus, or fungi.

In an embodiment, the invention relates to a method for preparing a treated cellulosic fiber comprising embedded silver nanoparticles, where the cellulosic fiber treated is not a swollen cellulosic fiber, where the method comprises immersing cellulosic fiber in a silver ion precursor solution at a set concentration in water; and maintaining the immersed fiber in the solution at a set temperature. The silver ion precursor is selected from the group consisting of silver nitrate, silver sulfate, and silver perchlorate. The solution optionally comprises at least one of a wetting agent, an ammonium source, and an alkali source. The method does not require adding a stabilizing agent, or adding a low concentration of a reducing agent reducing agent. In some embodiments of the invention, the cellulosic fiber used in the method for preparing treated cellulosic fiber comprising embedded silver nanoparticles is selected from the group consisting of scoured and bleached cotton, white cotton, naturally colored cotton, sticky cotton, flax, hemp, jute, ramie, pineapple leaf, and abaca. In some embodiments of the invention, the physical form of the cellulosic fiber used in the method for preparing treated cellulosic fiber comprising embedded silver nanoparticles is selected from a fiber, a yarn, a package, a fabric, a thread, a twine, a rope, a cloth, a woven fabric, a knitted fabric, a film-based composite, and a nonwoven fabric. In some embodiments of the invention, the silver ion precursor solution in the method for preparing treated cellulosic fiber comprising embedded silver nanoparticles comprises a wetting agent selected from the group consisting of polysorbate 20, polysorbate 60, polysorbate 80, polyethylene glycol, glycerin, thiodiglycol, diethylene glycol, urea, thiourea, dicyandiamide, and 4-(1,1,3,3-tetramethylbutyl)phenyl-polyethylene glycol). In some embodiments of the invention, the wetting agent is present from about 0.02 wt % to about 1 wt %.

In an embodiment, the invention relates to a first method for preparing a treated cellulosic fiber comprising embedded silver nanoparticles, where the cellulosic fiber treated is not a swollen cellulosic fiber, and where the method does not require adding a stabilizing agent, or adding a reducing agent. The first method comprises immersing cellulosic fiber in a solution of from about 0.001 mM to about 1 M silver ion precursor; and a wetting agent at about 80° C. to about 100° C. in DI water. In some embodiments of the invention, the cellulosic fiber treated by the first method is raw white cotton fiber, and the silver nanoparticles are formed embedded mostly on the cuticle and primary wall of the treated cellulosic fiber. In some embodiments of the invention, the cellulosic fiber treated by the first method is selected from the group consisting of naturally colored cotton, sticky cotton, flax, hemp, jute, ramie, pineapple leaf, and abaca, and the silver nanoparticles are formed embedded throughout the treated cellulosic fiber. In some embodiments, the invention relates to a cellulosic fiber comprising embedded silver nanoparticles prepared by the first method.

In an embodiment, the invention relates to a second method for preparing a treated cellulosic fiber comprising embedded silver nanoparticles, where the cellulosic fiber treated is not a swollen cellulosic fiber, and where the method does not require adding a reducing agent or adding a stabilizing agent. The second method comprises immersing cellulosic fiber in a solution of about 0.001 mM to about 1 M silver ion precursor solution in tap water, comprising a wetting agent, at about 80° C. to about 100° C. In some embodiments of the invention the second method comprises immersing cellulosic fiber in a solution of about 0.005 mM to about 20 mM silver ion precursor, about 0.03 wt % to about 0.06 wt % wetting agent, at about 80° C. to about 100° C. In some embodiments of the invention, the silver nanoparticles formed by the second method are formed embedded throughout the treated cellulosic fiber. In some embodiments, the invention relates to a cellulosic fiber comprising embedded silver nanoparticles prepared by the second method.

In an embodiment, the invention relates to a third method for preparing a treated cellulosic fiber comprising embedded silver nanoparticles, where the cellulosic fiber treated is not a swollen cellulosic fiber, and where the method does not require adding a reducing agent or adding a stabilizing agent. The third method comprises immersing cellulosic fiber in about 0.001 mM to about 1 M silver ion precursor solution; from about 0.003 mM to about 3 M ammonium source; in DI water or tap water; at about 100° C. In some embodiments of the invention, the ammonium source is selected from the group consisting of ammonia, ammonium hydroxide, ammonium fluoride, ammonium chloride, ammonium bromide, ammonium iodide, ammonium acetate, ammonium carbonate, ammonium carbamate, ammonium nitrite, ammonium nitrate, ammonium hydrogen sulfate, ammonium sulfate, ammonium thiosulfate, ammonium trifluoromethanesulfonate, ammonium tetrafluoroborate, ammonium perchlorate, chlorate, chlorite, ammonium dihydrogenphosphate, ammonium hydrogen phosphate, ammonium phosphate, and ammonium phosphite. In some embodiments, the invention relates to a cellulosic fiber comprising embedded silver nanoparticles prepared by the third method.

In an embodiment, the invention relates to a fourth method for preparing a treated cellulosic fiber comprising embedded silver nanoparticles, where the cellulosic fiber treated is not a swollen cellulosic fiber. The fourth method comprises immersing cellulosic fiber in about 0.001 mm to about 1 M silver ion precursor solution; about 0.022 mM to about 22 M ammonium source; from about 0.0012 wt % to about 50 wt % alkali source; in DI water at about 20° C. to about 100° C. In some embodiments of the invention, the alkali source is selected from sodium hydroxide, sodium carbamate, sodium carbonate, lithium hydroxide, lithium carbamate, lithium carbonate, potassium hydroxide, potassium carbamate, potassium carbonate, rubidium hydroxide, rubidium carbamate, rubidium carbonate, cesium hydroxide, cesium carbamate, cesium carbonate, beryllium hydroxide, beryllium carbamate, beryllium carbonate, magnesium hydroxide, magnesium carbamate, magnesium carbonate, calcium hydroxide, calcium carbamate, and calcium carbonate. In some embodiments of the invention, the fourth method comprises immersing cellulosic fiber in a solution of from about 0.5 mM to about 5 mM silver ion precursor solution, from about 30 mM to about 50 mM ammonium source, from about 1 wt % to about 2.5 wt % alkali source, in DI water, at about 20° C. to about 24° C. In some embodiments, the invention relates to a cellulosic fiber comprising embedded silver nanoparticles prepared by the fourth method.

In an embodiment, the invention relates to a fifth method for preparing a treated cellulosic fiber comprising embedded silver nanoparticles, where the cellulosic fiber treated is not a swollen cellulosic fiber. The fifth method comprises immersing cellulosic fiber in about 0.001 mm to about 1 M silver ion precursor; about 0.022 mM to about 22 M ammonium source; about 0.0012 wt % to about 50 wt % alkali source; DI water; at about 40° C. to about 100° C. In some embodiments of the invention, the fifth method for preparing treated cellulosic fiber comprising embedded silver nanoparticles comprises immersing cellulosic fiber in a solution of from about 0.5 mM to about 5 mM silver ion precursor; from about 30 mM to about 50 mM ammonium source; from about 1 wt % to about 2.5 wt % alkali source; from about 0.02 wt % to about 1 wt % wetting agent; in DI water at about 40° C. to about 100° C. In some embodiments, the invention relates to a cellulosic fiber comprising embedded silver nanoparticles prepared by the fifth method.

In an embodiment, the invention relates to a sixth method for preparing a treated cellulosic fiber comprising embedded silver nanoparticles, where the cellulosic fiber treated is not a swollen cellulosic fiber. The sixth method comprises immersing a cellulosic fiber in about 0.001 mM to about 1 M silver ion precursor; about 0.0000057 wt % to about 50 wt % alkali source; in tap water, at about 60° C. to about 100° C. In some embodiments of the invention, the sixth method comprises immersing cellulosic fiber in a solution of from about 0.5 mM to about 5 mM silver ion precursor, from about 0.005 wt % to about 0.02 wt % alkali source; in DI water, at about 60° C. to about 100° C. In some embodiments, the invention relates to a treated cellulosic fiber comprising embedded silver nanoparticles prepared by the sixth method.

In an embodiment, the invention relates to a seventh method for preparing treated cellulosic fiber comprising embedded silver nanoparticles. The method comprises immersing swollen cellulosic fiber in about 0.001 mM to about 1 M silver ion precursor; about 0.0033 mM to about 3.3 M ammonium source; at about 20° C. to about 100° C. In some embodiments of the invention, the seventh method for preparing treated cellulosic fibers comprising embedded nanoparticles comprises immersing swollen cellulosic fiber in a solution of from about 10 mM to about 20 mM silver ion precursor, from about 40 mM to about 55 mM ammonium source, in DI water, at about 20° C. to about 100° C. In some embodiments of the invention, when performing the seventh method of forming silver nanoparticles embedded in cellulosic fibers, the cellulosic fiber is swollen by immersing in a highly alkaline solution prior to immersing in silver ion precursor and ammonium source. In some embodiments of the invention, at least about 90% of the swollen treated cellulosic fiber comprises embedded silver nanoparticles. In some embodiments of the invention, silver nanoparticles are formed embedded in at least about 90% of the swollen treated fibers.

### BRIEF DESCRIPTION OF THE DRAWINGS

FIG. 1A and FIG. 1B depict graphs of the UV/Vis absorbance spectra obtained for raw cottons, either untreated, or treated as in Example 1. FIG. 1A shows the results for raw white cotton. A vertical dotted arrow indicates the surface plasmon resonance peak centered at 420 nm wavelength. FIG. 1B shows the results for raw naturally brown cotton. A vertical dotted arrow indicates the surface plasmon resonance peak centered at 415 nm wavelength. A dashed line shows the results obtained for untreated cotton; a dash-dotted line shows the results obtained for cotton treated at 80° C.; and a solid line shows the results obtained for cotton treated at 100° C. The Y axis shows the measured UV/Vis absorbance, and X axis shows the wavelength in nm.

FIG. 2 depicts a time course graph of the surface plasmon resonance absorbance obtained for raw cotton treated as in Example 1. Data obtained for treated raw white cotton are shown with triangles, and data obtained for treated raw naturally brown cotton are shown with circles. The Y axis shows the surface plasmon resonance absorption peak intensity, and the X axis shows the treating time in minutes.

FIG. 3 depicts a graph of the surface plasmon resonance absorbance obtained for various cottons treated as in Example 1. The Y axis shows the intensity of surface plasmon resonance absorption peak intensity, and X axis shows the kind of cotton treated (raw white, raw sticky white, scoured and bleached white, raw naturally brown, and raw naturally green).

FIG. 4 depicts a graph of the UV/Vis absorbance spectra obtained for scoured and bleached white cotton treated as in Example 2. A dash-dotted line shows data for cotton treated in DI water; and a solid line shows data for cotton treated in tap water. The Y axis shows the measured UV/Vis absorbance, and X axis shows the wavelength in nm.

FIG. 5A and FIG. 5B depict graphs of the UV/Vis absorbance spectra obtained for cottons treated as in Example 3. In FIG. 5A a dash-dotted line shows data for treated raw white cotton; a solid line shows data for treated raw sticky white cotton; and a dashed line shows data for treated scoured and bleached white cotton. In FIG. 5B a dash-dotted line shows data for treated raw naturally brown cotton; and a solid line shows data for treated raw naturally green cotton. The Y axis shows the measured UV/Vis absorbance, and X axis shows the wavelength in nm.

FIG. 6 depicts a time course graph of the surface plasmon resonance absorbance obtained for scoured and bleached white cotton treated as in Example 4. Data obtained for cotton treated at room temperature are shown with triangles, and data obtained for cotton treated at 40° C. are shown with circles. The Y axis shows the surface plasmon resonance absorption peak intensity, and the X axis shows the treating time in minutes.

FIG. 7 depicts a time course graph of the surface plasmon resonance absorbance obtained for scoured and bleached white cotton treated as in Example 5. The Y axis shows the surface plasmon resonance absorption peak intensity, and the X axis shows the treating time in minutes.

FIG. 8A and FIG. 8B show optical microscope images of cotton fiber before and after treatment as in Example 6. FIG. 8A shows an image of untreated white cotton fiber. FIG. 8B shows an image of treated cotton fiber. Bar indicates 50 μm.

FIG. 9 depicts a graph of the UV/Vis absorbance spectra obtained for cotton fiber treated as in Example 6. The Y axis shows the measured UV/Vis absorbance, and X axis shows the wavelength in nm.

FIG. 10A to FIG. 10D depict transmission electron microphotographs of cross sections of raw cotton fibers treated as in Example 1, taken at different magnifications. FIG. 10A shows a lower magnification microphotograph of treated raw white cotton. Bar indicates 1 μm. FIG. 10B shows a higher magnification microphotograph of treated raw white cotton. Bar indicates 200 nm. FIG. 10C shows a lower magnification microphotograph of treated raw naturally brown cotton. Bar indicates 1 μm. FIG. 10D shows a higher magnification microphotograph of treated raw naturally brown cotton. Bar indicates 200 nm.

FIG. 11A and FIG. 11B depict transmission electron microphotographs, of cross sections of cotton fiber treated as in Example 6, taken at different magnifications and from different parts of the fiber. FIG. 11A shows a lower magnification image taken at the edge of the fiber. Bar indicates 0.5 μm. FIG. 11B shows a higher magnification image taken at the center of the fiber. Bar indicates 20 nm.

FIG. 12 depicts an Energy-Dispersive Spectrum (EDS) obtained from cotton fiber treated as in Example 6. The Y axis shows the X-ray counts, and the X axis shows the energy in KeV. Carbon, oxygen, copper, and silver peaks are identified.

FIG. 13A and FIG. 13B depict histograms of the silver nanoparticle sizes formed in cotton fibers treated as in Example 1. FIG. 13A shows data for treated raw white cotton. FIG. 13B shows data for treated raw naturally brown cotton. The X axis depicts the particle size in nm, and the Y axis depicts the frequency of each particle size.

FIG. 14A and FIG. 14B depict graphs of the percentage of UV/Vis intensity and of silver by ICP-MS remaining after different numbers of laundering cycles in cottons treated as in Example 1. FIG. 14A shows data for treated raw white cotton. FIG. 14B shows data for treated raw naturally brown cotton. The UV/Vis intensity data are shown by white circles, and the inductively coupled plasma mass spectrometry (ICP-MS) data are shown by black circles. The Y axis shows the percentage (%) of UV/Vis intensity and of silver by ICP-MS remaining in the treated cotton. The X axis shows the number of laundering cycles.

FIG. 15 depicts a graph of the surface plasmon resonance absorbance obtained before and after laundering cottons treated as in Example 3. White bars depict data before laundering, and black bars depict data after 50 laundering cycles. The Y axis shows the intensity of surface plasmon resonance absorption peak; and the X axis shows the type of cotton.

FIG. 16A and FIG. 16B depict transmission electron microphotographs of cross sections of scoured and bleached white cotton fibers treated as in Example 3. FIG. 16A shows a microphotograph obtained before laundering. FIG. 16B shows a microphotograph obtained after 50 laundering cycles. Bars indicate 1 μm.

FIG. 17 depicts a graph of the percentage UV/Vis intensity and of silver by ICP-MS remaining in cotton treated as in Example 4 after different numbers of laundering cycles. The Y axis shows the percentage (%) of UV/Vis intensity and of silver by ICP-MS remaining in the treated cotton. The X axis shows the number of laundering cycles. The UV/Vis intensity data are shown by white circles, and the silver by ICP-MS data are shown by black circles.

FIG. 18A and FIG. 18B depict graphs of the silver nanoparticles remaining after various laundering cycles in textiles comprising 1% or 2% cotton fiber treated by the method of Example 6. FIG. 18A shows the UV/Vis spectra. The Y axis shows the percentage (%) of surface plasmon resonance intensity remaining in the treated cotton; and the X axis shows the number of laundering cycles. FIG. 18B shows the remaining silver concentration. The Y axis shows the silver concentration in the treated cotton measured by ICP-MS; and the X axis shows the number of laundering cycles. Data obtained for textiles comprising 1% cotton fiber treated as in Example 6 are shown with triangles; and data obtained for textiles comprising 2% cotton fiber treated as in Example 6 are shown with circles.

FIG. 19A and FIG. 19B depict graphs of the UV/Vis spectra obtained after scouring and bleaching raw cotton, either untreated or treated as in Example 1. FIG. 19A shows data obtained for raw white cotton. FIG. 19B shows data obtained for raw naturally brown cotton. A dash-dotted line shows data for untreated raw cotton; and a solid line shows data for treated raw cotton. The Y axis shows the measured UV/Vis absorbance; and X axis shows the wavelength in nm.

FIGS. 20A and 20B depict graphs of the bacterial reduction capacity remaining after different numbers of laundering cycles in untreated cotton and in cotton treated as in Example 1. FIG. 20A shows data obtained for raw white cotton. FIG. 20B shows data obtained for raw naturally brown cotton. White bars depict S. aureus viability and black bars depict P. aeruginosa viability. The Y axis show the percentage (%) reduction of bacterial viability; and the X axis shows the number of laundering cycles.

FIG. 21 depicts a graph of the bacterial reduction capacity of nonwoven fabrics prepared with 1% to 20% cotton fiber treated as in Example 6. White bars depict S. aureus viability and black bars depict P. aeruginosa viability. The Y axis show the percentage (%) reduction of bacterial viability; and the X axis shows the % blend ratio of the treated cotton fiber.

FIG. 22 depicts a graph of the bacterial reduction capacity of nonwoven fabrics prepared with 0.2% to 1% cotton fiber treated as in Example 6. White bars depict S. aureus viability and black bars depict P. aeruginosa viability. The Y axis shows the percentage (%) reduction of bacterial viability; and the X axis shows the % blend ratio of the treated cotton fiber.

FIG. 23A and FIG. 23B depict graphs of the bacterial reduction capacity remaining in nonwoven fabrics prepared with 1% or 2% cotton fiber treated as in Example 6 after different numbers of laundering cycles. FIG. 23A depicts percent S. aureus viability. FIG. 23B depicts percent P. aeruginosa viability. The Y axis show the percentage (%) reduction of bacterial viability; and the X axis shows the number of laundering cycles. White bars depict results for textiles comprising 1% treated cotton fiber, and black bars depict results for textiles comprising 2% treated cotton fiber.

### DETAILED DESCRIPTION

The inventors have developed methods of forming silver nanoparticles embedded in the substructures of cellulosic fibers. The silver nanoparticles formed by the methods of the invention remain embedded in the cellulosic fibers even after many laundering cycles. Cellulosic fibers with embedded silver nanoparticles prepared by the methods of the invention retain effective antimicrobial properties even after many laundering cycles.

In an embodiment, the invention relates to treated cellulosic fiber comprising embedded silver nanoparticles, and methods for the formation of silver nanoparticles embedded in the treated cellulosic fibers. Treated cellulosic fibers with embedded silver nanoparticles may be prepared with any available cellulosic fiber. In some embodiments of the invention the cellulosic fiber treated to form embedded silver nanoparticles is selected from the group consisting of cotton, flax, hemp, jute, ramie, pineapple leaf, and abaca. In some embodiments of the invention, the cellulosic fiber treated to form embedded silver nanoparticles is selected from the group consisting of scoured and bleached cotton fiber, white cotton fiber, naturally colored cotton fiber, sticky cotton fiber.

Cotton is unique among crop plants in that it produces seed trichomes, or fibers, that consist of extremely elongated single cells. Four separate cotton species have been domesticated independently. Gossypium hirsutum and G. barbadense are cotton species from the Americas, and G. arboretum and G. herbaceum are from Africa-Asia. At least five major types of cotton are currently grown commercially around the world: American upland, Egyptian, Sea-Island, Asiatic, and American Pima. The various kinds of cotton plants resemble each other in most ways, but they differ in such characteristics as color of flowers, character of fibers, and time of blooming. In addition, each main type has varieties with different characteristics, for example, some varieties grow best on irrigated land, the fibers produced by some of the cotton types are about one and three quarter inches long, while the fibers produced by other cotton types are only about half an inch long, and the fibers produced by some cotton varieties are stronger than the fibers produced other cotton varieties.

Each cotton fiber is a single cell. Under the microscope, a cotton fiber looks like a very fine, twisted ribbon, or a collapsed and twisted tube. The seed end of the fiber is quite irregular, having been torn during ginning from the epidermis or skin of the cotton seed. A cotton fiber may be anywhere from half an inch to two and three quarter inches in length and ranges from 11 μm to 22 μm in diameter. Cellulose is a major component of the cell walls that surround all plant cells. Cotton fibers may be thought as the dried out remains of extraordinarily long and thick cell walls. The cotton fibers are mostly made of cellulose, a macromolecule made up of anhydroglucose units connected by 1, 4 oxygen bridges with the polymer repeating unit being anhydro-beta-cellulose. Cotton cellulose has higher degrees of polymerization and crystallinity than wood and rayon cellulose. Higher degrees of polymerization and crystallinity of polymers are associated with higher strengths. Cotton fibers are easily visible to the naked eye, reaching lengths of up to 2 inches (5.08 cm). Fibers from domesticated cotton are the longest cells of any plant. Cotton fiber is a single biological cell with a multilayer structure. A cotton fiber cross-section is oval, and from the outside of the fiber to the inside, the layers in a mature cotton fiber cell: cuticle, primary wall, winding or transition layer, secondary wall, and lumen. The cuticle is the outer layer of a cotton fiber, it contains various non-cellulosic components such as pectin, proteins, sugars, and wax, and is a few molecules thick. The cuticle is removed from the fiber by scouring. The primary wall is the original thin cell wall. Each cell wall consists of microfibrils, which are randomly aligned in the winding layer and the primary wall, and are unidirectionally aligned at different angles to the fiber axis in the secondary wall. The size of typical cellulosic microfibrils ranges from ten to twenty nm in width with an average aspect ratio of twenty to one hundred. The lumen is the hollow space in the center of the fiber. The lumen is initially filled with living protoplast, which dries out when the fiber matures.

The internal structure of cotton fiber greatly swells in a concentrated alkaline solution, causing irreversible changes in the characteristics of the cotton fiber, e.g., uncoiling of the twisted ribbon-like fiber shape into a smoother rounder shape. Moreover, under alkaline treatment, the crystalline structure is altered from cellulose Iβ to cellulose II (Gardner K. H. and Blackwell J, 1974, “The structure of native cellulose,” Biopolymers 13(10): 1975-2001; Sarko A. and Muggli R., 1974, “Packing analysis of carbohydrates and polysaccharides. III. Valonia cellulose and cellulose II,” Macromolecules 7(4): 486-494). This alkaline treatment, called mercerization, has traditionally been conducted to enhance the luster, strength, and dye affinity of cotton fiber.

The color of cotton fibers depends on the cotton type, and the environmental conditions such as the soil, and climate under which it is grown. Different strains or types of cotton have different characteristics. Many of these differences arise from variations in genes which may affect fiber length, amount, quality, and color. Cotton plants with two copies of a certain genetic variation make naturally colored fibers. When this plant is bred with one that makes white fibers, the offspring make fibers intermediate in color. Genetic variations result in cotton plants that make naturally white cotton fiber, or naturally colored cotton fibers that are beige, brown, red, earth brown, chocolate brown, gray, and green. Representative “colored cottons” are brown and green.

American Upland Cotton is the type of white cotton most commonly cultivated in the South and Southwest of the United States of America. It constitutes about 95% of all cotton produced in the United States. The American Upland Cotton has short to medium staple fibers. Sticky cotton fibers are cotton fibers having sugars. These sugars may be derived from insect deposition, or may be free plant sugars found in immature fibers. The sugars in sticky cotton include glucose, fructose, sucrose, and other types of sugars. Oils released by crushed seed coat fragments are also a source of raffinose. As stickiness reduces fiber processing efficiency and yarn quality, it causes negative impacts on cotton sales and prices.

Naturally colored cotton is believed to have originated in the American Andes around 5000 years ago. Today, naturally colored cotton mostly comes from pre-Columbian stocks created by the indigenous peoples of South America. Naturally colored cottons exist in various hues including light to dark brown, red, rust, and green. The compositional differences between naturally colored cottons and white cottons include cellulose content, hemicellulose content, epicuticular wax content, mineral content, other non-cellulosic component content, and cellulose crystallinity. Throughout the 1990s, naturally colored cottons with superior fiber qualities were produced, e.g., brown fiber cotton germplasm lines designated “Buffalo” and “Coyote” by Dr Sally Fox, founder of VRESEIS LIMITED (Brooks, Calif., U.S.A.) The brown color derives from a tannin precursor, catechin, and tannin derivatives, which are concentrated in the lumen of the fiber. Green cotton derives its color from suberin, which is deposited in numerous concentric rings with cellulose. The constituents of the suberin layers are caffeic acid and glycerol. A myriad of variations in the color of the fibers provide an environmentally friendly alternative to chemical dyeing, allowing the textile industry to reduce processing costs by using less water and energy, and comply more easily with environmental regulations. Brown cottons were also demonstrated to have increased flame retardant properties compared with conventional white fiber cotton varieties. With these advantages, naturally colored cottons provide solutions for minimizing conventional chemical processing and occupy niche textile markets that promote the use of colors and self-extinguishing properties in the natural state.

White cotton fiber is commonly scoured and bleached. Scouring removes natural hydrophobic components such as oil and wax from the surface of the fiber, improving the efficiency of bleaching, dyeing, and finishing processes. Bleaching removes the natural pigment from cotton fiber. Most or all non-cellulosic components are removed from raw cotton fiber that has been scoured and bleached.

Cotton fibers are made into threads, yarn, and fabric in three steps: preparation, spinning, and weaving. Preparation of cotton has many steps. Cotton is first dried to reduce the moisture content, it is then cleared of debris such as dirt, seeds, burrs, stems, and leaf material. Once clean and dry, the cotton fiber is plucked from the seed by circular saws with small, sharp teeth, and packed into bales for processing. Cotton fibers are shaved from the bales and sent through a series of cleaning and drying machines. Carding machines then finish the cleaning and straightening of the fibers making them into a soft, untwisted rope called a sliver. The sliver is drawn out to a thinner strand and given a slight twist to improve strength, then wound on bobbins. The wound cotton is called roving, and the roving bobbins are ready for spinning. In the spinning process, roving is drawn and twisted into yarn and put onto bobbins. Looms then weave the cotton yarns into fabrics. Before weaving, most single spun yarns undergo the sizing (slashing) process, in which size (starch) is applied on the yarns. Sizing strengthens yarns and removes hairs (loose fibers protruding from the yarn surface) to help them withstand a wide range of mechanical stresses of bending, oscillating tension, and frictional resistance during the weaving process. Without the application of size, yarns are easily broken, causing losses in material, quality, and production time. After weaving into a fabric, the protective coating of starch is removed by a desizing process.

Cotton's strength, absorbency, and capacity to be washed and dyed make it adaptable to a considerable variety of textile products. Cotton textiles can be made into more kinds of products than textiles made with any other fiber. For example, apparel, home furnishings, and industrial products may be manufactured with cotton textiles, or textiles containing at least one cotton fiber. Cotton textiles are used in home furnishings, for example, towels, window shades, and bedding, such as bedspreads, pillowcases, pillow shams, mattress covers, and sheets. Industrial products containing cotton textiles may be wall coverings, book bindings, zipper tapes, medical supplies, industrial thread, and tarpaulins. Cotton fiber can be woven or knitted into fabrics such as velvet, corduroy, chambray, velour, jersey and flannel. Additionally, cotton textiles may be used for apparel products such as underwear, socks, and t-shirts. Cotton textiles are also used in the preparation of fishnets, coffee filters, book binding, and archival paper. Cotton may also be used to produce goods such as bandages, swabs, bank notes, cotton buds, and x-rays.

Cotton is currently the most widely produced natural fiber on the planet. A fabric made of 100% cotton is known for its comfort and durability. Cotton fiber can be woven or knitted into many different types of fabric, providing a slightly different feel and wear. A fabric made of 100% cotton is fully breathable, and can be cooler to wear in hot conditions. However, the breathability of a cotton fabric decreases as the thickness increases. Cotton canvas is a very durable and abrasion-resistant fabric, but it is very thick and heavy. Fabrics made of 100% cotton tend to rip and wear out easily, depending on the weave. Unless they are treated for fire-resistance, cotton fibers tend to burn away, and polyester will melt. As a natural fiber, 100% cotton garments also tend to be a bit more expensive than the synthetic counterparts. Polyester has an equal number of advantages and disadvantages as cotton. Polyester does not breathe and has a tendency to stick to the skin once perspiration begins. Polyester is a more elastic fiber than cotton, and therefore tends to be tear resistant. However, polyester does not tend to be as abrasion-resistant as cotton canvas. Polyester fabric is usually considerably cheaper than 100% cotton fabric. A fabric made from a polyester/cotton blend combines the strengths of the two fibers. Polyester/cotton garments are breathable, and tear-resistant. While not as inexpensive as pure polyester, garments made of polyester/cotton blends tend to cost less than comparable garments made of 100% cotton while providing much more comfort

Ramie (Boehmeria nivea), commonly known as China grass or rhea is chemically classified as a cellulosic fiber. Ramie fiber is often blended with cotton and available in woven and kinit fabrics that resemble fine linen to coarse canvas. Ramie fibers are found in the bark of the stalk, and the process of transforming ramie fiber into fabric is similar to manufacturing linen form flax. Ramie fiber is very fine and silk-like, is naturally white in color, and has a high luster. Ramie is one of the strongest natural fibers, and its strength is better when wet. The inner structure of ramie contains carbohydrate structural components.

The inventors have conceived different methods to use silver ion precursors to form silver nanoparticles embedded in cellulosic fibers. Using at least one of the methods conceived by the inventors, the silver nanoparticles are formed in the outer layers of the treated cellulosic fibers. Using at least one of the methods conceived by the inventors, the silver nanoparticles are formed throughout the treated cellulosic fibers, in the inner and outer layers of the fibers. The silver nanoparticles formed embedded in the treated cellulosic fibers are nearly spherical and have an average size of at least about 2 nm to at least about 30 nm. Using these methods, silver nanoparticles are formed embedded in the treated cellulosic fibers. None of the methods taught in the instant application for forming silver nanoparticles in cellulosic fibers use a stabilizing agent or a reducing agent.

In some embodiments of the invention, silver nanoparticles embedded in cellulosic fiber may be formed by treating using at least one of the methods of the invention cellulosic fibers, or at least one article such as a yarn, a thread, a twine, a rope, a cloth, a woven fabric, a nonwoven fabric, a knitted fabric, a film-based composite, and a final article comprising at least one cellulosic fiber. Silver nanoparticles embedded in treated cellulosic fiber may be formed by exposing at least one cellulosic fiber, or at least one article comprising at least one cellulosic fiber to a precursor of silver nanoparticles. In some embodiments of the invention, silver nanoparticles are formed embedded in cellulosic fiber, when the cellulosic fiber is immersed in an aqueous silver ion precursor solution. The aqueous silver ion precursor solution may comprise silver nitrate, silver sulfate; or silver perchlorate. In some embodiments of the invention, silver nanoparticles embedded in cellulosic fibers may be obtained by any one of the methods taught in Examples 1 to 6 below. A silver ion precursor solution may be prepared, for example, with a silver ion precursor and a wetting agent in DI water; with a silver ion precursor and a wetting agent in tap water; with a silver ion precursor, an ammonium source, and a wetting agent in DI water or tap water; with a silver ion precursor, an ammonium source, an alkali source, and a wetting agent in DI water; with a silver ion precursor, and an alkali source in tap water; or with a silver ion precursor, an ammonium source, and an alkali source in DI water.

In some embodiments of the invention, a method of forming silver nanoparticles embedded in cellulosic fiber uses an ammonium source. The ammonium source may be selected from the group consisting of ammonia, ammonium hydroxide, ammonium fluoride, ammonium chloride, ammonium bromide, ammonium iodide, ammonium acetate, ammonium carbonate, ammonium carbamate, ammonium nitrite, ammonium nitrate, ammonium hydrogen sulfate, ammonium sulfate, ammonium thiosulfate, ammonium trifluoromethanesulfonate, ammonium tetrafluoroborate, ammonium perchlorate, chlorate, chlorite, ammonium dihydrogenphosphate, ammonium hydrogen phosphate, ammonium phosphate, and ammonium phosphite.

In some embodiments of the invention, a method of forming silver nanoparticles embedded in cellulosic fiber uses an alkali source. The alkali source may be selected from the group consisting of sodium hydroxide, sodium carbamate, sodium carbonate, lithium hydroxide, lithium carbamate, lithium carbonate, potassium hydroxide, potassium carbamate, potassium carbonate, rubidium hydroxide, rubidium carbamate, rubidium carbonate, cesium hydroxide, cesium carbamate, cesium carbonate, beryllium hydroxide, beryllium carbamate, beryllium carbonate, magnesium hydroxide, magnesium carbamate, magnesium carbonate, calcium hydroxide, calcium carbamate, and calcium carbonate.

In some embodiments of the invention, a method of forming silver nanoparticles embedded in cellulosic fiber uses a wetting agent. Wetting agents, also called surfactants, increase the spreading and penetrating properties of a liquid by lowering its surface tension. A wetting agent may be, for example, polysorbate 20, polysorbate 60, polysorbate 80, polyethylene glycol, glycerin, thiodiglycol, diethylene glycol, urea, thiourea, dicyandiamide, TRITON X-100 (4-(1,1,3,3-tetramethylbutyl)phenyl-polyethylene glycol). TRITON X-100 is a registered trademark currently owned by Union Carbide, for 4-(1,1,3,3-tetramethylbutyl)phenyl-polyethylene glycol.

Textile materials with embedded silver nanoparticles are advantageous due to the stability and large surface to volume ratio of the silver nanoparticles. In an embodiment, the invention relates to an article comprising at least one treated cellulosic fiber comprising embedded silver nanoparticles, where the fiber treated is not a swollen cellulosic fiber. In some embodiments of the invention, the article comprising embedded silver nanoparticles is selected from the group consisting of a yarn, a thread, a twine, a rope, a cloth, a woven fabric, a knitted fabric, a film-based composite, a nonwoven fabric, and a final article. In some embodiments of the invention, the article comprising at least one treated cellulosic fiber is selected from the group consisting of athletic wear, an undergarment, military wear, a medical textile, a washable sanitizing wipe, a disposable sanitizing wipe, a film-based fiber-containing composite, a functional barrier, a towel, a bedding, a shoe liner, a garment liner, or a curtain. In some embodiments of the invention, the medical textile is selected from the group consisting of a curtain, a bedding, a surgical arena fabric, a surgical personnel protective garment, and a wound or non-wound patient dressing, a bandage, a gauze, a packing, or a cleaning material. In some embodiments of the invention, an article comprising at least one treated cellulosic fiber comprising embedded silver nanoparticles is antimicrobial, antibacterial, anti-odor, antiviral, or anti-fungal.

UV/Vis spectra were obtained for the cellulosic fibers treated by the methods of the invention, using a wavelength range from 220 to 1,200 nm in an ISR-2600 spectrometer. Surface resonance absorption peaks were observed at about 420 nm or at about 415 nm for all treated cellulosic materials tested, suggesting the presence of nearly spherical silver nanoparticles in the cellulosic materials treated as in Examples 1 to 6.

In an embodiment of the invention, silver nanoparticles formed embedded in treated cotton fiber are nearly spherical, and have an average size of at least about 2 nm. In some embodiments of the invention, the nearly spherical silver nanoparticles embedded in treated cotton fiber have an average size of at least about 2 nm to at least about 30 nm. In some embodiments of the invention, the nearly spherical silver nanoparticles embedded in treated cotton fiber have an average size of about 10.9 nm. In some embodiments of the invention, the nearly spherical silver nanoparticles embedded in treated cotton fiber have an average size of about 15.7 nm. In some embodiments of the invention, the nearly spherical silver nanoparticles embedded in treated cotton fiber have an average size of about 10.9 nm, and the treated cotton is treated raw white cotton. In some embodiments of the invention, the nearly spherical silver nanoparticles embedded in treated cotton have an average size of about 15.7 nm and the treated cotton is treated raw naturally brown cotton. The nearly spherical silver nanoparticles appeared to have a different particle size distribution pattern depending on the type of cotton treated. In some embodiments of the invention, the silver nanoparticles in treated white cotton fiber are from about 2.5 nm to about 25 nm, with an average size of about 10.9±4.9 nm. In some embodiments of the invention, the silver nanoparticles in treated raw naturally brown cotton fiber are from about 2.5 nm to about 30 nm, with an average size of about 15.7±5.2 nm. Silver nanoparticles formed in lightly-punched cotton, after immersing in sodium hydroxide, padding, and immersing in silver nitrate and ammonium hydroxide at room temperature appeared spherical-like, and their size was 9.7±3.2 nm with a narrow size distribution.

Surface plasmon resonance absorption intensity measurements of fibers treated with a silver ion precursor and a wetting agent in DI water at 100° C. for 2 hours, indicated a negligible amount of silver nanoparticles in scoured and bleached white cotton fiber, but a significant amount of silver nanoparticles in treated raw cotton fibers including raw white cotton, raw sticky white cotton, raw naturally brown cotton, and raw naturally green cotton.

ICP-MS was used to measure the concentrations of silver nanoparticles formed in treated cotton fibers. In raw cotton fiber treated with silver nitrate in DI water at about 100° C. for about 2 hours, the concentration of silver in treated white cotton fiber was about 314 mg/kg, and the concentration of silver in treated brown cotton fiber was about 10,567 mg/kg. The concentration of silver nanoparticles formed in scoured and bleached cotton fiber treated with 5 mM silver nitrate, 15 mM ammonium hydroxide, in DI water at 100° C. for 0.25 hours was about 13,153 mg/kg.

In an embodiment, the invention relates to treated cellulosic fiber comprising embedded silver nanoparticles where the cellulosic fiber treated are not swollen cellulosic fibers. In some embodiments of the invention, the silver nanoparticles are physically and chemically trapped inside the fiber. Not being bound by theory, it is believed that following the methods taught in the instant application, silver nanoparticles are formed between the internal structural elements of the treated cellulosic fibers, and that positive silver ions present on the surface of these silver nanoparticles bind electrostatically with neighboring electron-rich oxygen atoms present in the fiber components.

In an embodiment, the invention relates to treated cellulosic fibers where silver nanoparticles are formed by treating by Method A cellulosic fibers that are not swollen cellulosic fibers. In cellulosic fibers treated by Method A, silver nanoparticles are formed embedded in the outer layers (cuticle and primary wall) of treated raw white cotton fiber, and are formed embedded throughout treated naturally colored cotton, sticky cotton, flax, hemp, jute, ramie, pineapple leaf, or abaca fibers. In some embodiments of the invention, silver nanoparticles are formed embedded when treating raw white cotton fiber, naturally colored cotton fiber, sticky cotton fiber, flax fiber, hemp fiber, jute fiber, ramie fiber, pineapple leaf fiber, or abaca fiber with Method A, which comprises with from about 0.001 mM to about 1 M of a silver ion precursor; about 0.02 wt % to about 0.1 wt % wetting agent; in DI water, at about 80° C. to about 100° C. In some embodiments, the invention relates to treated raw white cotton fiber comprising silver nanoparticles formed embedded in the outer layers of the fiber, where the fiber is treated by Method A. In some embodiments, the invention relates to treated naturally colored cotton, sticky cotton, flax, hemp, jute, ramie, pineapple leaf, or abaca fibers comprising silver nanoparticles formed embedded throughout the treated fiber, where the fiber is treated by Method A. In some embodiments, Method A comprises treating cellulosic fiber with about 1 mM to about 10 mM silver ion precursor; about 0.02 wt % to about 1 wt % wetting agent; in DI water at about 80° C. to about 100° C. for at least about 1 minute. In some embodiments of the invention, treated raw white cotton fiber comprising embedded silver nanoparticles embedded in the outer layers, and treated naturally colored cotton, sticky cotton, flax, hemp, jute, ramie, pineapple leaf, or abaca fibers comprising silver nanoparticles embedded throughout the treated fiber are formed by treating the cellulosic fibers with about 1 mM to about 10 mM silver nitrate; about 0.02 wt % to about 1 wt % 4-(1,1,3,3-tetramethylbutyl)phenyl-polyethylene glycol); in DI water at about 80° C. to about 100° C., for at least 1 minute. The cellulosic fibers are not swollen fibers.

In an embodiment, the invention relates to treated cellulosic fibers comprising silver nanoparticles embedded throughout, where the cellulosic fibers are treated by Method B, and are not wollen cellulosic fibers. In some embodiments, Method B comprises treating cellulosic fibers with about 0.001 mM to about 1 M silver ion precursor; about 0.02 wt % to about 1 wt % wetting agent, in tap water at about 80° C. to about 100° C., for at least 1 minute. In some embodiments of the invention, the cellulosic fiber treated by Method B is selected from white cotton, sticky cotton, naturally colored cotton, scoured and bleached cotton, flax, hemp, jute, ramie, pineapple leaf, and abaca. In some embodiments of the invention, silver nanoparticles are formed in cellulosic fibers treated with about 1 mM to about 10 mM silver nitrate; about 0.02 wt % to about 1 wt % 4-(1,1,3,3-tetramethylbutyl)phenyl-polyethylene glycol), in tap water at about 80° C. to about 100° C., for at least 1 minute.

In an embodiment, the invention relates to treated cellulosic fibers comprising silver nanoparticles embedded throughout, where the cellulosic fibers are treated by Method C, and are not swollen cellulosic fibers. In some embodiments, Method C comprises treating cellulosic fibers with about 0.001 mM to about 1 M silver ion precursor; about 0.003 mM to about 3.0 M ammonium source; about 0.02 wt % to about 1 wt % wetting agent; in DI water or tap water at about 100° C., for at least 1 minute. In some embodiments of the invention, the cellulosic fiber treated by Method C is selected from white cotton, sticky cotton, naturally colored cotton, scoured and bleached cotton, flax, hemp, jute, ramie, pineapple leaf, and abaca. In some embodiments of the invention, silver nanoparticles are formed in cellulosic fibers treated with about 1 mM to about 10 mM silver nitrate; about 10 mM to about 20 mM ammonium hydroxide; about 0.02 wt % to about 1 wt % 4-(1,1,3,3-tetramethylbutyl)phenyl-polyethylene glycol), in DI water or tap water at about 80° C. to about 100° C., for at least 1 minute.

In an embodiment, the invention relates to treated cellulosic fibers comprising silver nanoparticles embedded throughout, where the cellulosic fibers are treated by Method D, and are not swollen cellulosic fibers. In some embodiments, Method D comprises treating cellulosic fibers with about 0.001 mM to about 1 M silver ion precursor; about 0.022 mM to about 22 M ammonium source; about 0.0012 wt % to about 50 wt % alkali source; about 0.02 wt % to about 1 wt % wetting agent; in DI water at about 20° C. to about 100° C., for at least 1 minute. In some embodiments of the invention, the cellulosic fiber treated by Method D is selected from white cotton, sticky cotton, naturally colored cotton, scoured and bleached cotton, flax, hemp, jute, ramie, pineapple leaf, and abaca. In some embodiments of the invention, silver nanoparticles are formed in cellulosic fibers treated with about 0.5 mM to about 5 mM silver nitrate; about 30 mM to about 50 mM ammonium hydroxide; about 1 wt % to about 2.5 wt % sodium hydroxide; about 0.02 wt % to about 1 wt % 4-(1,1,3,3-tetramethylbutyl)phenyl-polyethylene glycol), in DI water at about 20° C. to about 100° C., for at least 1 minute.

In an embodiment, the invention relates to treated cellulosic fibers comprising silver nanoparticles embedded throughout, where the cellulosic fibers are treated by Method E, and are not swollen cellulosic fibers. In some embodiments, Method E comprises treating cellulosic fibers with about 0.001 mM to about 1 M silver ion precursor; about 0.022 mM to about 22 M ammonium source; about 0.0012 wt % to about 50 wt % alkali source; about 0.02 wt % to about 1 wt % wetting agent; in DI water at about 40° C. to about 100° C., for at least 1 minute. In some embodiments of the invention, the cellulosic fiber treated by Method E is selected from white cotton, sticky cotton, naturally colored cotton, scoured and bleached cotton, flax, hemp, jute, ramie, pineapple leaf, and abaca. In some embodiments of the invention, silver nanoparticles are formed in cellulosic fibers treated with about 0.5 mM to about 5 mM silver nitrate; about 30 mM to about 50 mM ammonium hydroxide; about 1 wt % to about 2.5 wt % sodium hydroxide; about 0.02 wt % to about 1 wt % 4-(1,1,3,3-tetramethylbutyl)phenyl-polyethylene glycol), in DI water at about 40° C. to about 100° C., for at least 1 minute.

In an embodiment, the invention relates to treated cellulosic fibers comprising silver nanoparticles embedded throughout, where the cellulosic fibers are treated by Method F, and are not swollen cellulosic fibers. In some embodiments, Method F comprises treating cellulosic fibers with about 0.001 mM to about 1 M silver ion precursor; about 0.0012 wt % to about 50 wt % alkali source; in tap water at about 60° C. to about 100° C., for at least 1 minute. In some embodiments of the invention, the cellulosic fiber treated by Method F is selected from white cotton, sticky cotton, naturally colored cotton, scoured and bleached cotton, flax, hemp, jute, ramie, pineapple leaf, and abaca. In some embodiments of the invention, silver nanoparticles are formed in cellulosic fibers treated with about 0.5 mM to about 5 mM silver nitrate; about 0.0000057 wt % to about 50 wt % sodium hydroxide; in tap water at about 60° C. to about 100° C., for at least 1 minute.

In an embodiment, the invention relates to treated cellulosic fibers comprising silver nanoparticles embedded throughout, where the cellulosic fibers are treated by Method G are swollen cellulosic fibers. In some embodiments, Method G comprises treating swollen cellulosic fibers with about 0.001 mM to about 1 M silver ion precursor; about 0.003 mM to about 3.3 M ammonium source; in DI water at about 20° C. to about 100° C., for at least 1 minute. In some embodiments of the invention, the cellulosic fiber treated by Method G is selected from swollen white cotton, sticky cotton, naturally colored cotton, scoured and bleached cotton, flax, hemp, jute, ramie, pineapple leaf, and abaca. In some embodiments of the invention, silver nanoparticles are formed in swollen cellulosic fibers treated with about 10 mM to about 20 mM silver nitrate; about 45 mM to about 55 mM ammonium hydroxide; in DI water at about 60° C. to about 100° C., for at least 1 minute.

In an embodiment, the invention relates to a Method A for forming silver nanoparticles embedded mostly on the outer layers of treated raw white cotton fiber, or throughout (outer and inner layers) of treated ramie, cotton, flax, hemp, jute, pineapple leaf, abaca, or sticky cotton fibers, where the cellulosic fiber is not a swollen cellulosic fiber, and where the method does not require adding a stabilizing agent, or adding a reducing agent. In some embodiments, Method A comprises immersing cellulosic fiber in a solution of from about 0.001 mM to about 1 M silver ion precursor; and about 0.02 wt % to about 0.1 wt % wetting agent at about 80° C. to about 100° C. in DI water. In some embodiments of the invention, the cellulosic fiber treated by Method A is raw white cotton fiber, and the silver nanoparticles are formed embedded mostly on the cuticle and primary wall of the treated cellulosic fiber. In some embodiments of the invention, the cellulosic fiber treated by Method A is selected from the group consisting of naturally colored cotton, sticky cotton, flax, hemp, jute, ramie, pineapple leaf, and abaca, and the silver nanoparticles are formed embedded throughout the treated cellulosic fiber.

In an embodiment, the invention relates to a Method B for forming silver nanoparticles embedded throughout (in the inner layers and outer layers) cellulosic fiber, where the cellulosic fiber is not a swollen cellulosic fiber. In some embodiments, Method B comprises treating cellulosic fibers with about 0.001 mM to about 1 M silver ion precursor; about 0.02 wt % to about 1 wt % wetting agent, in tap water at about 80° C. to about 100° C., for at least 1 minute. In some embodiments of the invention, the cellulosic fiber treated by Method B is selected from white cotton, sticky cotton, naturally colored cotton, scoured and bleached cotton, flax, hemp, jute, ramie, pineapple leaf, and abaca. In some embodiments of the invention, silver nanoparticles are formed in cellulosic fibers treated with about 1 mM to about 10 mM silver nitrate; about 0.02 wt % to about 1 wt % 4-(1,1,3,3-tetramethylbutyl)phenyl-polyethylene glycol), in tap water at about 80° C. to about 100° C., for at least 1 minute.

In an embodiment, the invention relates to a Method C for forming silver nanoparticles embedded throughout (inner layers and outer layers) cellulosic fiber, where the cellulosic fiber is not a swollen cellulosic fiber. In some embodiments, Method C comprises treating cellulosic fibers with about 0.001 mM to about 1 M silver ion precursor; about 0.003 mM to about 3.0 M ammonium source; about 0.02 wt % to about 1 wt % wetting agent; in DI water or tap water at about 100° C., for at least 1 minute. In some embodiments of the invention, the cellulosic fiber treated by Method C is selected from white cotton, sticky cotton, naturally colored cotton, scoured and bleached cotton, flax, hemp, jute, ramie, pineapple leaf, and abaca. In some embodiments of the invention, silver nanoparticles are formed in cellulosic fibers treated with about 1 mM to about 10 mM silver nitrate; about 10 mM to about 20 mM ammonium hydroxide; about 0.02 wt % to about 1 wt % 4-(1,1,3,3-tetramethylbutyl)phenyl-polyethylene glycol), in DI water or tap water at about 80° C. to about 100° C., for at least 1 minute.

In an embodiment, the invention relates to a Method D for forming silver nanoparticles embedded throughout (inner layers and outer layers) cellulosic fiber, where the cellulosic fiber is not a swollen cellulosic fiber. In some embodiments, Method D comprises treating cellulosic fibers with about 0.001 mM to about 1 M silver ion precursor; about 0.022 mM to about 22 M ammonium source; about 0.0012 wt % to about 50 wt % alkali source; about 0.02 wt % to about 1 wt % wetting agent; in DI water at about 20° C. to about 100° C., for at least 1 minute. In some embodiments of the invention, the cellulosic fiber treated by Method D is selected from white cotton, sticky cotton, naturally colored cotton, scoured and bleached cotton, flax, hemp, jute, ramie, pineapple leaf, and abaca. In some embodiments of the invention, silver nanoparticles are formed in cellulosic fibers treated with about 0.5 mM to about 5 mM silver nitrate; about 30 mM to about 50 mM ammonium hydroxide; about 1 wt % to about 2.5 wt % sodium hydroxide; about 0.02 wt % to about 1 wt % 4-(1,1,3,3-tetramethylbutyl)phenyl-polyethylene glycol), in DI water at about 20° C. to about 100° C., for at least 1 minute.

In an embodiment, the invention relates to a Method E for forming silver nanoparticles embedded throughout (inner layers and outer layers) cellulosic fiber, where the cellulosic fiber is not a swollen cellulosic fiber. In some embodiments, Method E comprises treating cellulosic fibers with about 0.001 mM to about 1 M silver ion precursor; about 0.022 mM to about 22 M ammonium source; about 0.0012 wt % to about 50 wt % alkali source; about 0.02 wt % to about 1 wt % wetting agent; in DI water at about 40° C. to about 100° C., for at least 1 minute. In some embodiments of the invention, the cellulosic fiber treated by Method E is selected from white cotton, sticky cotton, naturally colored cotton, scoured and bleached cotton, flax, hemp, jute, ramie, pineapple leaf, and abaca. In some embodiments of the invention, silver nanoparticles are formed in cellulosic fibers treated with about 0.5 mM to about 5 mM silver nitrate; about 30 mM to about 50 mM ammonium hydroxide; about 1 wt % to about 2.5 wt % sodium hydroxide; about 0.02 wt % to about 1 wt % 4-(1,1,3,3-tetramethylbutyl)phenyl-polyethylene glycol), in DI water at about 40° C. to about 100° C., for at least 1 minute.

In an embodiment, the invention relates to a Method F for forming silver nanoparticles embedded throughout (inner layers and outer layers) cellulosic fiber, where the cellulosic fiber is not a swollen cellulosic fiber. In some embodiments, Method F comprises treating cellulosic fibers with about 0.001 mM to about 1 M silver ion precursor; about 0.0012 wt % to about 50 wt % alkali source; in tap water at about 60° C. to about 100° C., for at least 1 minute. In some embodiments of the invention, the cellulosic fiber treated by Method F is selected from white cotton, sticky cotton, naturally colored cotton, scoured and bleached cotton, flax, hemp, jute, ramie, pineapple leaf, and abaca. In some embodiments of the invention, silver nanoparticles are formed in cellulosic fibers treated with about 0.5 mM to about 5 mM silver nitrate; about 0.0000057 wt % to about 50 wt % sodium hydroxide; in tap water at about 60° C. to about 100° C., for at least 1 minute.

In an embodiment, the invention to relates to a Method G for forming silver nanoparticles embedded throughout (inner layers and outer layers) swollen cellulosic fiber. In some embodiments, Method G comprises treating swollen cellulosic fibers with about 0.001 mM to about 1 M silver ion precursor; about 0.003 mM to about 3.3 M ammonium source; in DI water at about 20° C. to about 100° C., for at least 1 minute. In some embodiments of the invention, the cellulosic fiber treated by Method G is selected from swollen white cotton, sticky cotton, naturally colored cotton, scoured and bleached cotton, flax, hemp, jute, ramie, pineapple leaf, and abaca. In some embodiments of the invention, silver nanoparticles are formed in swollen cellulosic fibers treated with about 10 mM to about 20 mM silver nitrate; about 45 mM to about 55 mM ammonium hydroxide; in DI water at about 60° C. to about 100° C., for at least 1 minute.

In some embodiments of the invention, swollen cellulosic fibers are obtained by immersing cellulosic fibers in a high concentration alkali solution at about 18° C. to about 30° C. In some embodiments of the invention, the alkali solution is selected from sodium hydroxide, sodium carbamate, sodium carbonate, lithium hydroxide, lithium carbamate, lithium carbonate, potassium hydroxide, potassium carbamate, potassium carbonate, rubidium hydroxide, rubidium carbamate, rubidium carbonate, cesium hydroxide, cesium carbamate, cesium carbonate, beryllium hydroxide, beryllium carbamate, beryllium carbonate, magnesium hydroxide, magnesium carbamate, magnesium carbonate, calcium hydroxide, calcium carbamate, and calcium carbonate.

Silver nanoparticles formed in the internal structure of cellulosic fibers are leach-resistant to consecutive launderings. Particularly, silver nanoparticles produced in treated raw naturally brown cotton appear to be more leach-resistant than the silver nanoparticles produced in treated raw white cotton. The retention of embedded silver nanoparticles in treated cellulosic fibers was determined by applying AATCC Test Method 61-2007 to fabrics made with at least one cellulosic fiber comprising embedded silver nanoparticles of the invention, and the silver nanoparticle content examined during consecutive laundering cycles up to 50 laundering cycles. The amount of silver remaining in the fabrics prepared with treated cellulosic fibers was measured using inductively coupled plasma mass spectrometry (ICP-MS), and the change in the amount of silver nanoparticles remaining on the fabric was monitored using surface plasmon resonance absorption intensity using UV/Vis spectroscopy. In some embodiments of the invention, after at least 5, 10, 15, 20, 25, 30, 35, 40, 45, or 50 laundering cycles fabric comprising at least one cellulosic fiber comprising embedded silver nanoparticles of the invention retains at least about 50%, at least about 55%, at least about 60%, at least about 65%, at least about 70%, at least about 75%, at least about 80%, at least about 85%, at least about 90%, at least about 95%, at least about 96%, at least about 97%, at least about 98%, at least about 99% of the silver as measured by ICP-MS. In some embodiments of the invention, after at least 5, 10, 15, 20, 25, 30, 35, 40, 45, or 50 laundering cycles fabric comprising at least one cellulosic fiber comprising embedded silver nanoparticles of the invention retains at least about 50%, at least about 55%, at least about 60%, at least about 65%, at least about 70%, at least about 75%, at least about 80%, at least about 85%, at least about 90%, at least about 95%, at least about 96%, at least about 97%, at least about 98%, at least about 99% of the silver nanoparticles as measured by surface plasmon resonance absorption peak intensity.

Silver nanoparticles formed in the inner and outer layers of cellulosic fibers are leach-resistant to scouring and bleaching. In an embodiment, at least about 90%, at least about 85%, at least about 80%, at least about 75%, at least about 70% of the silver nanoparticles remain in the cellulosic fiber after scouring and bleaching raw cellulosic fiber comprising embedded silver nanoparticles formed by a method of the invention.

In an embodiment, the invention relates to the use of treated cellulosic fiber comprising embedded silver nanoparticles to kill or inhibit growth of microbes, bacteria, virus, and/or fungi. In some embodiments of the invention, the treated cellulosic fiber comprising embedded silver nanoparticles may be used to treat or prevent a broad spectrum of bacteria, fungi, and chlamydia. Examples of such bacteria, fungi, and chlamydia may be Escherichia coli, Methicillin resistant Staphylococcus aureus, Chlamydia trachomatis, Providencia stuartii, Vibrio vulnificus, Pneumobacillus, Nitrate-negative bacillus, Candida albicans, Bacillus cloacae, Bacillus allantoides, Salmonella morgani, Pseudomonas maltophila, Pseudomonas aeruginosa, Neisseria gonorrhoeae, Bacillus subtilis, Bacillus foecalis alkaligenes, Streptococcus hemolyticus B, Citrobacter, and Salmonella paratyphi C.

Treated cellulosic fibers retain antibacterial properties against Gram-positive Staphylococcus aureus ATCC 6538 (S. aureus) and Gram-negative Pseudomonas aeruginosa ATCC 15442 (P. aeruginosa) after at least five laundering cycles. Viability reductions of Gram-positive and Gram-negative bacteria in treated cellulosic fibers comprising embedded silver nanoparticles were measured after different number of laundering cycles. The washing durability test used was based on the AATCC Test Method 61-2007: Colorfastness to Laundering: Accelerated. In some embodiments of the invention, after at least 5, 10, 15, 20, 25, 30, 35, 40, 45, or 50 laundering cycles treated cellulosic fiber retain at least about 50%, at least about 55%, at least about 60%, at least about 65%, at least about 70%, at least about 75%, at least about 80%, at least about 85%, at least about 90%, at least about 95%, at least about 96%, at least about 97%, at least about 98%, at least about 99% antibacterial properties against Gram-positive and Gram-negative bacteria.

In an embodiment, the invention relates to an article comprising at least one cellulosic fiber comprising embedded silver nanoparticles of the invention. In some embodiments, the article comprising embedded silver nanoparticles is selected from the group consisting of a yarn, a thread, a twine, a rope, a cloth, a woven fabric, a knitted fabric, a film-based composite, a nonwoven fabric, a finished article. In some embodiments, the invention relates to a finished article comprising at least one fiber comprising embedded silver nanoparticles of the invention. In some embodiments, the invention relates a finished article selected from film-based fiber-containing composites, functional barriers, bandages, gauze, surgery cloth, undergarments, shoe cushions, shoe and garment linings, bedding, pillow shams, towels, feminine hygiene products, medical robes, etc. In an embodiment, the invention relates to athletic wear, an undergarment, military wear, a medical textile, a washable sanitizing wipe, or a disposable sanitizing wipe, a film-based fiber-containing composite, a functional barrier, a towel, a bedding, a shoe liner, a garment liner, or a curtain comprising at least one treated cellulosic fiber comprising embedded silver nanoparticles. In some embodiments of the invention, the medical textile comprising at least one treated cellulosic fiber comprising embedded silver nanoparticles is selected from the group consisting of a curtain, a bedding, a surgical arena fabric, a surgical personnel protective garment, and a wound or non-wound patient dressing, a bandage, a gauze, a packing, or a cleaning material. In some embodiments, the invention relates to antimicrobial, antibacterial, antiviral, or antifungal medical devices comprising at least one treated cellulosic fiber comprising embedded silver nanoparticles of the invention.

The treated cellulosic fibers comprising embedded silver nanoparticles of the invention, release silver ions in a controlled manner while retaining most of the silver nanoparticles. As a result, long lasting protection against harmful bacteria can be achieved using textiles comprising at least one treated cellulosic fiber of the invention.

The methods taught in the instant application allow for the formation of silver nanoparticles within the interior of the treated cellulosic fiber. Because the silver nanoparticle growth occurs on the solid surface of microfibrils, the methods of the instant invention prevent particle aggregation and immobilize the silver nanoparticles retaining effective antimicrobial properties and laundering durability.

In an embodiment of the invention, at least one treated cellulosic fiber comprising embedded silver nanoparticles of the invention is blended with at least one other type of fiber. In some embodiments, at least one other type of fiber is selected from the group consisting of an animal-based fiber, a plant-based fiber, a mineral-based fiber, and a synthetic fiber. Animal-based fibers include at least alpaca, angora wool, byssus, camel hair, cashmere wool, chiengora, lambswool, llama, mohair wool, qiviut, rabbit, silk, vicuña, and sheep wool. Plant-based fibers include at least abaca, wood pulp (acetate), bamboo, banana, kapok, coir (coconut), flax, hemp, jute, kenaf, lyocell, modal, raffia, raw ramie, rayon, and sisal. Synthetic fibers include at least acrylic, Kevlar, modacrylic, nomex, nylon, polyester, polypropylene, spandex, and rayon. The resulting fiber will retain the functional attributes of the treated cellulosic fiber comprising embedded silver nanoparticles of the invention.

As used herein, the term “about” is defined as plus or minus ten percent of a recited value. For example, about 1.0 g means 0.9 g to 1.1 g.

As used herein, the term “embedded” is used to define silver nanoparticles enclosed closely in or as in the fiber matrix, set firmly into a fiber mass or material.

As used herein, “embedded throughout” and “embedded in the outer and inner layers” are used interchangeably, to indicate that the silver nanoparticles are formed dispersed in all layers of the fiber (cuticle, primary wall, winding layer, secondary wall, and lumen).

As used herein, “embedded in the outer layers” means that the silver nanoparticles are embedded mostly on the cuticle and primary wall of the fiber.

As used herein, “outer layers” of a cotton fiber and “cuticle and primary wall” are used interchangeably and refer to the two most outer layers of a cotton fiber.

As used herein, a “fiber” is a unit of matter which is capable of being spun into a yarn or made into a fabric by bonding or by interlacing in a variety of methods including weaving, knitting, braiding, felting, twisting, or webbing, and which is the basic structural element of textile products.

As used herein, a “fabric” is any material nonwoven, woven, knitted, felted, or otherwise produced from, or in combination with, a treated cellulosic fiber comprising embedded silver nanoparticles of the invention.

As used herein, a “cloth” is a woven or felted fabric made from a fiber.

As used herein, a “yarn” is a strand of textile fiber in a form suitable for weaving, knitting, braiding, sewing, felting, webbing, or otherwise fabricating into a fabric.

As used herein, a nonwoven fabric is a fabric-like material made from short fibers (staple) and long fibers (continuous long), bonded together, for example, by needle-punching or hydroentanglement. The term is used in the textile manufacturing industry to denote fabrics, such as felt, which are neither woven nor knitted.

As used herein, “deionized water,” or “DI water” is water with all or almost all of its ions removed, and which has no charge.

As used herein, “tap water” is water which has not been distilled, or deionized. Tap water may contain various organic and inorganic compounds such as ferric sulfate, chlorine, ammonia, chloramines, calcium oxide, polyphosphates, fluoride, sodium chloride, and other naturally occurring inorganic salts.

In the instant application, “treated cellulosic fiber” and “cellulosic fiber comprising embedded silver nanoparticles” are used interchangeably and refer to cellulosic treated as in the examples in the application. Treated cellulosic fibers of the invention comprise embedded silver nanoparticles.

As used herein, “untreated fiber” is a control fiber, a fiber which has not been altered by the use of at least a portion of any one of the methods of the invention.

As used herein, an “outer layers of a cotton fiber” comprises the cuticle and primary wall of the cotton fiber.

As used herein, a “swollen cellulosic fiber” is a cellulosic fiber treated with a highly alkaline solution. In a fiber treated with a highly alkaline solution the crystalline structure is changed such that the orientation of the cellulose chains has been rearranged from parallel chains (cellulose Iβ) into anti-parallel chains (cellulose II).

As used herein, “embedded mostly on the outer layers” refers to silver nanoparticles that are largely all formed in the outer layers of the cellulosic fiber. It also refers to silver nanoparticles that are predominantly formed in the outer layers of the cellulosic fiber.

A silver ion precursor in the synthesis of nanoparticles embedded inside cellulosic fibers may be any silver salt, for example, silver nitrate, silver sulfate, or silver perchlorate.

An ammonium source in the synthesis of nanoparticles embedded inside cellulosic fibers may be ammonia, or an ammonium salt selected from the group consisting of ammonium hydroxide, ammonium fluoride, ammonium chloride, ammonium bromide, ammonium iodide, ammonium acetate, ammonium carbonate, ammonium carbamate, ammonium nitrite, ammonium nitrate, ammonium hydrogen sulfate, ammonium sulfate, ammonium thiosulfate, ammonium trifluoromethanesulfonate, ammonium tetrafluoroborate, ammonium perchlorate, ammonium chlorate, ammonium chlorite, ammonium dihydrogenphosphate, ammonium hydrogen phosphate, ammonium phosphate, and ammonium phosphite.

When referring to textiles or cotton, some terms have a meaning different from the meaning normally associated with them. For example,

When referring to textiles or cotton, “processing” is the mechanical or physical manipulation of fibers to achieve a desired physical form. Processing of cotton is commonly used to describe bale opening, cleaning, blending with other fiber types, carding, combing, spinning, and winding from a bale to a bobbin of yarn.

When referring to textiles, a “package” is a large bobbin or cylinder holding yarn.

When referring to textiles, a “yarn” is a spun thread.

When referring to textiles, “weaving” is the process by which yarn is turned into woven fabrics. A “woven fabric” consists essentially of two distinct sets of yarns or threads that are interlaced at right angles.

When referring to textiles, “knitting” is a process by which a yarn is turned into a knitted fabric. A “knitted fabric” consists essentially of parallel courses of yarn which are joined to each other by interlocking loops.

When referring to textiles, “nonwoven fabric” is a fabric-like material where the fibers are bonded together by chemical, mechanical, heat, or solvent treatment. Many methods are known in the art to prepare nonwoven fabrics, hydroentanglement and needle-punching are two such methods.

When referring to textiles, a “final article” or “utility article” is an item of utility produced most frequently by cutting and sewing fabric into an article.

When referring to textiles, “treatment” is used to describe a wet chemical modification of the fiber, such as scouring, bleaching, or dyeing. Less frequently “treatment” is used to describe a physical modification such as plasma, singeing, brush napping) of the cotton of the cotton fibers. Various treatments can be carried out on cotton in loose fiber form, yarn package form, fabric form (most common) or in finished article form.

When referring to textiles, “pre-treatment” or “preparation” include such things as scouring and bleaching.

### EXAMPLES

Having now generally described this invention, the same will be better understood by reference to certain specific examples, which are included herein only to further illustrate the invention and are not intended to limit the scope of the invention as defined by the claims.

### Example 1

### Treatment of Raw Cellulosic Fibers with Heat and Silver Nitrate in Deionized Water

Silver nanoparticles formed embedded in cellulosic fibers when heating cellulosic fibers at about 80° C. or at about 100° C. in a silver nitrate solution prepared in deionized (DI) water. When treating raw white cotton fiber, the silver nanoparticles formed embedded mostly on the cuticle and primary wall of the fiber. When treating raw ramie, raw sticky white cotton, and raw naturally colored cotton, the silver nanoparticles formed embedded throughout the fiber.

A 5 mM silver nitrate (AgNO₃, 99.9%; J. T. Baker Chemical Company, Phillipsburg, N.J., USA) solution was prepared in DI water. Commercially available mechanically pre-cleaned raw white cotton fiber was obtained from T. J. Beall, Greenwood, Miss., USA. Commercially available mechanically pre-cleaned raw naturally brown cotton fiber was obtained from VRESEIS Limited. Commercially available scoured and bleached white cotton fiber was obtained from Barnhardt Manufacturing Co., Charlotte, N.C., USA. Raw sticky white cotton fiber and raw naturally green cotton fiber were obtained from the Southern Regional Research Center (USDA-ARS, New Orleans, La., USA). Scoured, bleached, and desized white cotton print fabric (98 g/m²) was purchased from Testfabrics, Inc (West Pittston, Pa., USA). Raw ramie fiber was obtained from Beijing Key Laboratory of Lignocellulosic Chemistry, Beijing Forestry University, Tsinghua East Road, Beijing, 100083, China.

About one gram of cellulosic fibers were immersed in 25 ml of 5 mM silver nitrate in DI water containing 0.05 wt % TRITON X-100 (4-(1,1,3,3-tetramethylbutyl)phenyl-polyethylene glycol), and heated at about 100° C. or about 80° C. for about 0.2 hours to about 2 hours. After this time the fibers were removed from the silver nitrate solution, transferred into DI water, and washed with agitation for 12-16 hours at room temperature. The wash water was replaced about every hour for the first three hours, and the treated fibers were air-dried for about 1 to 4 hours.

Before treatment, the scoured and bleached white cotton fiber appeared white; the raw white cotton and the raw sticky white cotton appeared slightly yellow; the raw naturally brown cotton appeared brown; the raw naturally green cotton appeared with uneven green and brown patches; and the raw ramie appeared uneven light brown and green. Within several minutes after the start of heating the fibers at 100° C., the raw white cotton fiber and the raw sticky white cotton fiber turned yellow, and the raw naturally brown cotton fiber and the raw naturally green cotton fiber turned dark brown. The colors became darker as the reaction proceeded, with the treated raw white cotton and the treated raw sticky white cotton turning brown, and the treated raw naturally brown cotton, the treated raw naturally green cotton, and the treated raw ramie fiber turning dark brown. The scoured and bleached white cotton fiber showed a negligible color change. When heating the fibers at 80° C., the shades of colors for the raw white cotton fiber, the raw sticky white cotton fiber, the raw naturally brown cotton fiber, and the raw naturally green cotton fiber were lighter than those observed at 100° C. These color changes in the treated cellulosic fibers may be attributed to the surface plasmon resonance of metallic particles with sizes smaller than the wavelength of visible light.

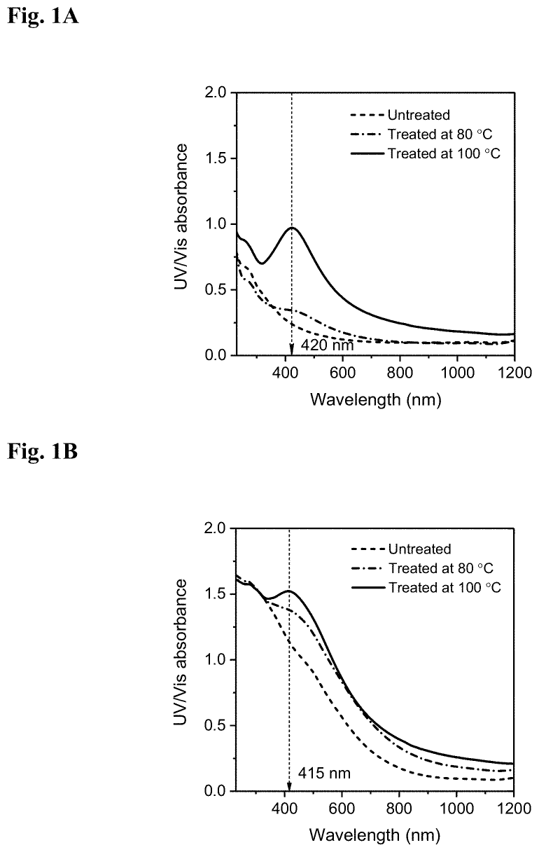

UV/Vis spectra were obtained using a wavelength range from 220 to 1,200 nm in a ISR-2600 UV/Vis spectrometer (Shimadzu Scientific Instruments; Columbia, Md., USA). Surface plasmon resonance absorption peaks were observed at 420 nm for treated raw white cotton, and at 415 nm for treated brown cotton in the UV/Vis spectra, suggesting the presence of nearly spherical silver nanoparticles on treated fibers. As seen in FIG. 1A, when treating raw white cotton fibers with silver nitrate in DI water, a surface resonance absorption peak was observed at about 420 nm (solid line) when treating at about 100° C., and a small surface resonance absorption peak was observed at about 420 nm when the cotton was treated at about 80° C. (dash-dotted line), while no plasmon absorption peak was discernable for untreated raw white cotton (dashed line). As seen in FIG. 1B, a plasmon absorption peak developed at about 415 nm for raw naturally brown cotton treated with silver nitrate in DI water at either about 100° C. (solid line) or at about 80° C. (dash-dotted line), while no plasmon absorption peak was discernable for untreated raw naturally brown cotton (dashed line). These absorbance peaks at 415 nm and 420 nm suggest the formation of nearly spherical silver nanoparticles in the treated raw cotton fiber. The absorbance intensity obtained for either fiber treated at 100° C. was higher than the absorbance intensity obtained for either fiber treated at 80° C. The extent of this increase was greater for the treated raw white cotton fiber than for the treated raw naturally brown cotton fiber. The absorbance intensity obtained for the treated raw naturally brown cotton fiber was higher than the absorption intensity obtained for the treated raw white cotton fiber. These results suggest that raw naturally brown cotton fiber produces silver nanoparticles more effectively than raw white cotton fiber. These results also indicate raw naturally brown cotton fiber can effectively produce silver nanoparticles when treated at a lower temperature (80° C.).

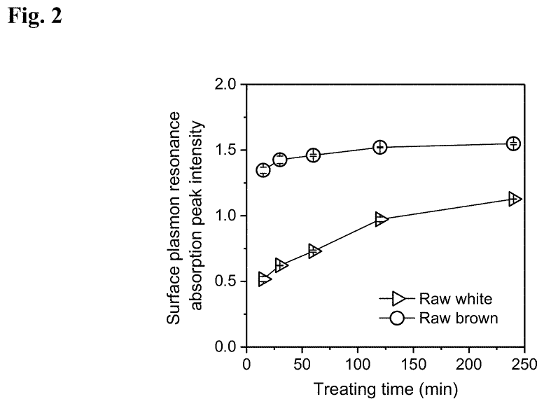

To monitor the formation of silver nanoparticles in treated cotton fibers over time, fibers were immersed in 5 mM silver nitrate in the presence of 0.05 wt % TRITON X-100, in DI water, and heated at 100° C. Treated fiber samples were obtained after heating for 0.25 hours, 0.5 hours, 1 hour, 2 hours, and 4 hours. The treated fiber samples were transferred into DI water, washed with agitation for 12-16 hours at room temperature, replacing the wash water every hour for the first three hours, and air-dried for 1-4 hours, and analyzed using UV/Vis spectroscopy. A time course graph of the surface plasmon resonance absorption peak intensity obtained for raw white cotton fiber and raw naturally brown cotton fiber treated with 5 mM silver nitrate in the presence of 0.05 wt % TRITON X-100 in DI water at about 100° C. is depicted in FIG. 2. In this figure, triangles show data for treated raw white cotton fiber, and circles show data for treated raw naturally brown cotton fiber. For treated raw white cotton, the absorbance intensity increased linearly for the first 2 hours of treating time, and the absorbance intensity increased at a slower rate after this time. For treated raw naturally brown cotton, the absorbance intensity increased rapidly within the first 30 minutes, increased at a slower rate between 30 minutes and 2 hours, and increased at an ever slower rate between 2 hours and 4 hours.

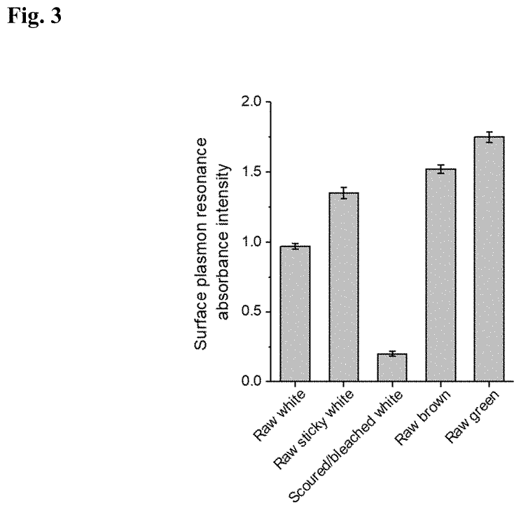

The capabilities of various raw cotton fibers to produce silver nanoparticles embedded within the fiber when treated with a silver nitrate solution in DI water at 100° C. for 2 hours were compared. Untreated cotton exhibits a baseline intensity in the UV/Vis spectrum, treated scoured and bleached white cotton fiber produced a very small increment. As seen in FIG. 3, the surface plasmon resonance absorption intensity for treated scoured and bleached white cotton fiber was below about 0.2; for treated raw white cotton fiber was about 1.0; for treated raw sticky white fiber was about 1.3; for treated raw naturally brown cotton fiber was about 1.55; for treated raw naturally green cotton fiber was about 1.8. In summary, the surface plasmon resonance absorption intensity was lowest for treated scoured and bleached white cotton; slightly higher for treated raw white cotton; higher for raw sticky white cotton; higher for raw naturally brown cotton; and even higher for raw naturally green cotton. The surface plasmon resonance absorption intensity for treated raw ramie was higher than that for treated raw white cotton. Raw colored cottons produced silver nanoparticles with higher efficiency than raw white cottons.

In summary, these results suggest that treating raw cellulosic fibers with 5 mM silver nitrate, 0.05 wt % TRITON X-100 in DI water, at 100° C. is appropriate for forming silver nanoparticles embedded in the raw cellulosic fibers, but are not appropriate for forming silver nanoparticles embedded in scoured and bleached white cotton fiber. The silver nanoparticles formed embedded in the cuticle and primary wall of the raw white cotton fiber, and embedded throughout raw sticky white cotton fiber and naturally colored cotton fiber.

### Example 2

### Treatment of Cotton Fibers with Heat and Silver Nitrate in Tap Water

Silver nanoparticles formed embedded throughout cotton fibers when heating cotton fibers in a silver nitrate solution in tap water. Silver nanoparticles were formed embedded throughout treated scoured and bleached white cotton fiber, treated raw white cotton fiber, treated raw sticky white cotton fiber, and treated raw naturally colored fiber.

A 5 mM silver nitrate solution was prepared in tap water. Cotton fibers and fabric were obtained as described in Example 1. About one gram of cotton fibers or fabrics were immersed in 25 ml of 5 mM silver nitrate in tap water in the presence of 0.05 wt % TRITON X-100. The fibers in the solution were heated for about 0.25 hours at about 100° C. After this time the fibers were removed from the silver nitrate solution, transferred into DI water, washed with agitation for 12-16 hours at room temperature, replacing the wash water every hour for the first three hours, and air-dried for 1-4 hours at room temperature.

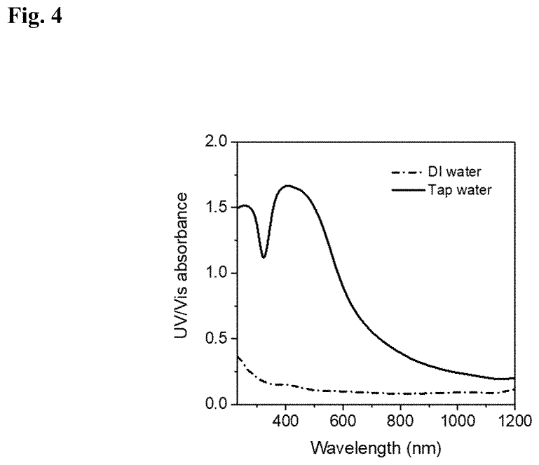

When the fibers or fabrics were treated with a silver nitrate solution in tap water at 100° C., the fibers or fabrics turned brown very quickly, and the reaction was stopped after about 0.25 hours. Silver nanoparticles were formed embedded throughout all the cotton fibers tested, except for scoured and bleached white cotton. A graph of the UV/Vis spectra of scoured and bleached white cotton fiber treated for 0.25 hours is shown in FIG. 4. The solid line on this graph shows that scoured and bleached white cotton fiber exhibited a high intensity surface plasmon resonance peak at about 420 nm when treated at 100° C. with a silver nitrate solution in tap water. The dash dotted line on this figure shows that when scoured and bleached white cotton fiber is treated with a silver nitrate solution in DI water no discernible plasmon peak is observed.

Silver nanoparticles embedded throughout the fiber were obtained when raw white cotton fiber, raw white sticky cotton fiber, and raw naturally colored cotton fibers were treated with silver nitrate solution in tap water at about 100° C., for about 0.25 hours. In view of the results presented in Example 1, it is expected that silver nanoparticles will form embedded throughout raw ramie fiber when treated as in the present example.

### Example 3

### Treatment of Cotton Fibers with Heat, Silver Nitrate, and Ammonium Hydroxide

Silver nanoparticles formed embedded throughout cotton fibers treated with silver nitrate and ammonium hydroxide at 100° C. for about 0.25 hours. When scoured and bleached white cotton fiber, raw white cotton fiber, raw sticky white cotton fiber, and raw naturally colored cotton fiber were treated with silver nitrate and ammonium hydroxide at 100° C. for about 0.25 hours, silver nanoparticles were formed embedded throughout the fiber.

A silver ion precursor solution was prepared by adding ammonium hydroxide solution (NH₄OH, 28-30%, Sigma Aldrich, St. Louis, Mo., USA) up to 15 mM to a 5 mM aqueous silver nitrate solution in DI water. Cotton fibers were obtained from the same sources as in Example 1. About one gram of fibers or fabrics were immersed in 25 ml of a silver ion precursor solution comprising 5 mM silver nitrate, 15 mM ammonium hydroxide, 0.05 wt % TRITON X-100. The fibers or fabrics in the solution were heated at about 100° C. for about 0.25 hours. After this time the fibers were removed from the silver ion precursor solution, transferred into DI water, washed with agitation for 12-16 hours at room temperature while replacing the wash water every hour for the first three hours, and air-dried for 1 to 4 hours.

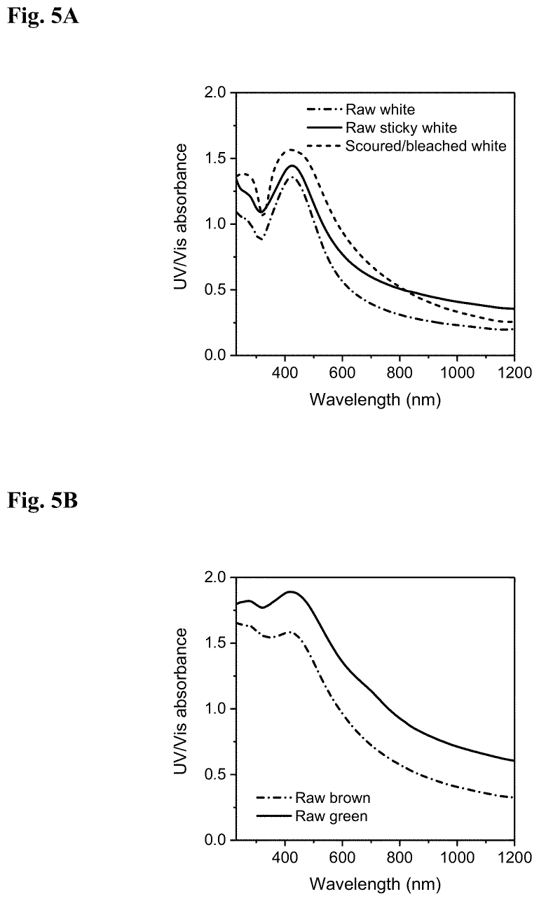

Shortly after the start of heating the fibers in 5 mM silver nitrate, 15 mM ammonium hydroxide, 0.05 wt % TRITON X-100 at about 100° C., the treated raw white cotton fiber turned dark yellow; the treated raw sticky white cotton fiber turned brown; and the treated scoured and bleached white cotton fiber, raw naturally cotton fiber, and raw naturally green cotton fiber turned dark brown. The colors became darker as the reaction proceeded. FIG. 5A and FIG. 5B show graphs of the UV/Vis absorbance for cotton treated with 5 mM silver nitrate, 15 mM ammonium hydroxide, 0.05 wt % TRITON X-100 at about 100° C. for about 0.25 hours. In FIG. 5A, a dash-dotted line shows the results for treated raw white cotton, a solid line shows the results for raw sticky white cotton, a dashed line shows the results for scoured and bleached white cotton. A strong plasmon absorption peak developed at about 425 nm for all three treated white cottons (raw white, raw sticky white, and scoured and bleached white). In FIG. 5B, a dash-dotted line shows the results for treated raw naturally cotton fiber, and a solid line shows the results for treated green cotton fiber. A plasmon absorption peak appeared at about 420 nm for treated raw naturally cotton fiber and treated raw naturally green cotton fiber. The higher absorption intensity observed for the treated scoured and bleached white cotton fiber indicates that pure white cotton (without noncellulosic components) can produce silver nanoparticles more efficiently than raw white cottons. The silver nanoparticles were embedded throughout the treated scoured and bleached white cotton fiber. Similar results were obtained when the cellulosic fibers were treated with 5 mM silver nitrate, 15 mM ammonium hydroxide, 0.05 wt % TRITON X-100 at about 100° C. for about 0.25 hours in tap water.

Silver nanoparticles embedded throughout the fiber were obtained when raw white cotton fiber, raw white sticky cotton fiber, and raw colored fibers were treated with silver nitrate and ammonium hydroxide at 100° C. for about 0.25 hours in either DI water or tap water. In view of the results presented in Example 1, it is expected that raw ramie will behave similarly.

### Example 4

### Treatment of Cotton Fibers with Silver Nitrate, Ammonium Hydroxide, and Sodium Hydroxide

Silver nanoparticles were formed embedded throughout cotton fibers treated with silver nitrate, ammonium hydroxide, and sodium hydroxide in DI water at either room temperature or 40° C. Silver nanoparticles formed embedded throughout scoured and bleached white cotton fiber, raw white cotton fiber, raw sticky white cotton fiber, and raw colored fiber treated with silver nitrate, ammonium hydroxide, and sodium hydroxide in DI water at room temperature for about 1 hour to at least about 16 hours, or at 40° C. for about 0.5 hours to at least about 1 hour.

A silver ion precursor solution was prepared by dissolving silver nitrate to 1.76 mM and 0.05 wt % TRITON X-100 in DI or tap water, adding 39.3 mM ammonium hydroxide (NH₄OH, Sigma Aldrich, St. Louis, Mo., USA), adding 8 ml of 10 wt % sodium hydroxide aqueous solution. Cotton fiber and fabric were obtained from the sources listed in Example 1. About 0.3 gram of cotton fiber or fabric were immersed in about 30 ml silver ion precursor solution. The fabric or fiber was kept in the silver ion precursor solution at room temperature for about 1 hour to at least about 16 hours, or at 40° C. for about 0.5 hours to at least about 1 hour. After this time the fabric or fiber was removed from the silver ion precursor solution, transferred into DI water, washed with agitation for 12-16 hours at room temperature while replacing the wash water every hour for the first three hours, and air-dried for 1-4 hours.

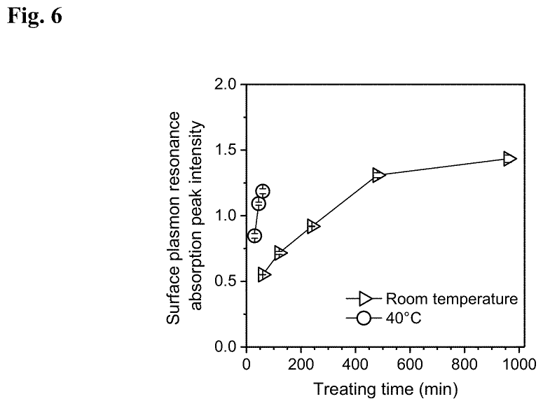

A time course graph of the surface plasmon resonance absorption peak intensity of scoured and bleached white cotton treated with silver nitrate, ammonium hydroxide, and sodium hydroxide in DI water is depicted in FIG. 6. In this figure, triangles depict data for treatment at room temperature, and circles depict data for treatment at 40° C. For fabric or fiber treated at room temperature, the rate of surface plasmon resonance peak intensity increased linearly between 1 hour and 8 hours, after which time the rate intensity increased at a slower rate to the last time point measured. For fabric or fiber treated with 5 mM silver nitrate, 15 mM ammonium hydroxide, 0.05 wt % TRITON X-100 at 40° C., the surface plasmon resonance peak intensity increased rapidly within 1.5 hours, after which time the reaction was stopped.

In summary, silver nanoparticles were formed embedded throughout scoured and bleached white cotton fabric or fiber when the fabric or fiber was treated with silver nitrate, ammonium hydroxide, and sodium hydroxide in DI water at room temperature or at 40° C. Similar results were obtained for raw white cotton fiber, raw white sticky cotton fiber, and raw colored cotton fiber. When the silver nitrate, ammonium hydroxide, and sodium hydroxide solutions were prepared in tap water, formation of silver nanoparticles using the methods in this example was less efficient.

### Example 5

### Treatment of Cotton Fibers with Heat, Silver Nitrate and Sodium Hydroxide in Tap Water

Silver nanoparticles were formed embedded throughout cotton fibers heated at about 60° C. in a solution of silver nitrate and sodium hydroxide in tap water. Silver nanoparticles were formed embedded throughout scoured and bleached white cotton fiber, raw white cotton fiber, raw sticky white cotton fiber, and raw colored fiber treated with silver nitrate and sodium hydroxide at 60° C. for about 2 hours to at least about 6 hours.

To 30 ml of 1.76 mM silver nitrate in tap water, 32 μL of 10 wt % sodium hydroxide solution was added. About 0.3 g of cotton fabric or fiber was immersed in the treating solution, and heated at 60° C. for about 2 hours to about 6 hours. After this time the fabric or fiber was removed from the solution, transferred into DI water, washed with agitation for 12-16 hours at room temperature while replacing the wash water every hour for the first three hours, and air-dried for 1 to 4 hours.

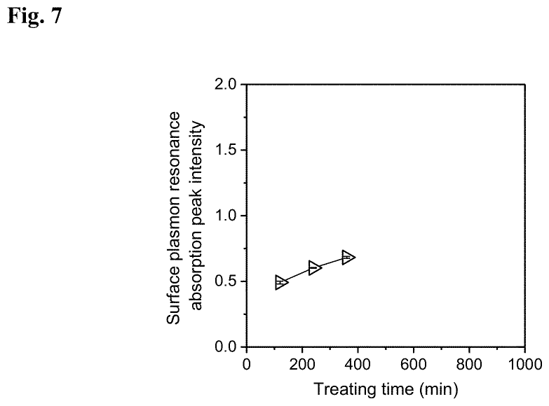

A time course graph of the surface plasmon resonance absorption peak intensity of scoured and bleached white cotton fiber treated with silver nitrate and sodium hydroxide in tap water at 60° C. is depicted in FIG. 7. The surface plasmon resonance peak intensity increased gradually from about 2 to about 6 hours of treatment. After 2 hours a negligible surface plasmon resonance peak intensity was observed when no sodium hydroxide was used, suggesting that in the present instance sodium hydroxide facilitated the formation of silver nanoparticles.

### Example 6

### Treatment of Swollen Cotton Fibers with Silver Nitrate and Ammonium Hydroxide

Silver nanoparticles formed embedded throughout, and evenly dispersed after immersion of swollen cotton fibers in 14.7 mM silver nitrate, 48.5 mM ammonium hydroxide solution in tap water at room temperature. This method does not use a reducing agent, such as ascorbic acid, and silver nanoparticles formed evenly embedded in all fibers immersed. Silver nanoparticles formed embedded throughout all the cellulosic fibers tested.

Sodium hydroxide (NaOH, 97%) and ammonium hydroxide solution (NH₄OH, 28-30%) were purchased from Sigma Aldrich (St. Louis, Mo., USA). Silver nitrate (AgNO₃, 99.9%) was purchased from J. T. Baker (Phillipsburg, N.J., USA). All chemicals were used as received. Mechanically pre-cleaned raw white cotton fiber was acquired from T. J. Beall (Greenwood, Miss., USA). Deionized (DI) water was used as the solvent. Nonwoven fabrics were fabricated in the nonwoven pilot plant at the Southern Regional Research Center (USDA-ARS, New Orleans, La., USA).

To efficiently obtain individual cotton fibers comprising silver nanoparticles embedded throughout, prior to treatment with a silver ion precursor, a lightly needle-punched nonwoven fabric was prepared, and the fibers swollen by immersion in an aqueous alkaline solution at high-concentration. This highly alkaline solution (about 20 wt % sodium hydroxide) swells and opens the microfibrillar structure, and causes the cellulose chains to irreversible rearrange from parallel chains (cellulose Iβ) to anti-parallel chains (cellulose II). The excess sodium hydroxide solution was removed from the fabric by padding.

A lightly needle-punched nonwoven fabric was produced by chute-feeding raw white cotton fibers to a tandem card (Crosrol UK Ltd, Bradford, United Kingdom). This produced a fiber web of about 9 g/m² and directly delivered into a cross-lapper (TECHNOplants s.r.l., Pistoia, Italy). The card web was cross-lapped 16 times and fed into a needle-punch machine (TECHNOplants s.r.l.) equipped with boards of 3 barb, 9 cm needles (Groz-Beckert KG, Albstadt, Germany). The needling process was carried out with 350 strokes per minute and a production rate of 5 m/min. The density of the fabric was 60±5 g/m².

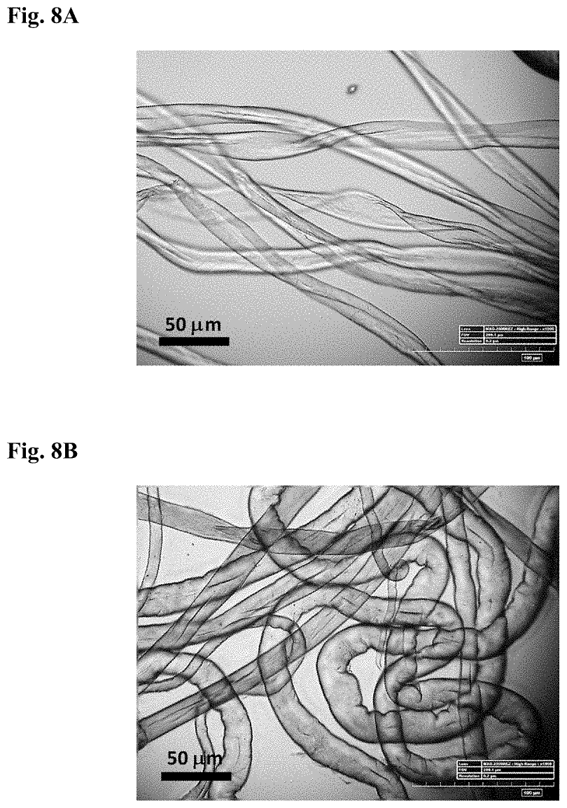

To swell the fibers, approximately 1 g of a lightly needle-punched raw white cotton fabric was immersed and agitated in 20 ml of a 20 wt % sodium hydroxide aqueous solution in DI water at room temperature for 15 minutes. The fabric was then placed between paper towels and passed through a laboratory padder (Werner Mathis USA Inc., Concord, N.C., USA) at a pressure of 0.3 MPa and a padder speed of 2 m/min. The resulting wet-pick-up was 200±5%. The fabric was transferred to 30 ml of 14.7 mM silver nitrate, 48.5 mM ammonium hydroxide and agitated for 15 minutes at room temperature. Starting almost immediately, the raw cotton fabric gradually turned from white to bright yellow and then brown. This color change may be attributed to the surface plasmon resonance of silver nanoparticles, whose size is smaller than the wavelength of visible light. The treated fabric was transferred into DI water, washed with agitation for 12 to 16 hours at room temperature, while replacing the wash water every hour for the first three hours, and air-dried for 1 to 4 hours. Due to the lubricity of raw cotton, the lightly needle-punched fabric was easily pulled apart into fibers. Optical microscopy images of the treated cotton fibers showed that a yellow color appeared uniformly throughout the sample. An optical microscopy image of non-treated cotton fiber is shown in FIG. 8A, and an optical microscopy image of treated cotton fiber is shown on FIG. 8B. These images show that the alkali treatment caused the intrinsic, flat and twisted, ribbon-like structure of the cotton fiber to disappear and the fibers to become rounder and fatter due to swelling.

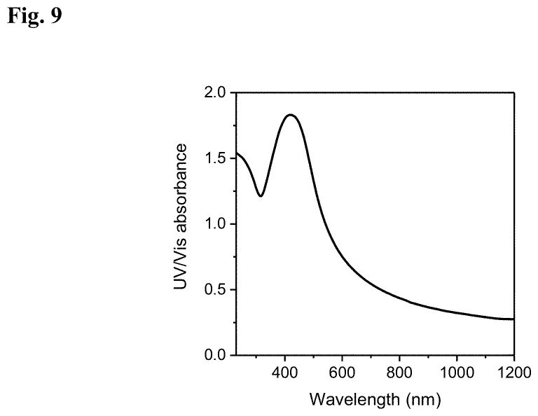

As shown in the UV/Vis spectrum of FIG. 9, lightly needle-punched white cotton nonwoven fabric treated with a sodium hydroxide aqueous solution followed by treatment with silver nitrate and ammonium hydroxide, at room temperature exhibited a surface plasmon resonance peak with a high intensity at about 420 nm. It is expected that any cellulosic fiber treated as in this example, will produce silver nanoparticles embedded in the swollen fibers.

When treated by the methods of this Example, silver nanoparticles formed evenly distributed in all fibers treated. No large, black particles were formed on the surface of the fiber. The process was carried out at room temperature, and no ascorbic acid was used.

### Example 7

### Microscopy Analyses

The distribution of silver nanoparticles formed embedded in cellulosic fibers was analyzed using transmission electron microscopy. Silver nanoparticles formed accumulating mostly towards the outer layers (cuticle and primary wall) of raw white cotton fibers treated with a silver nitrate solution in DI water. Silver nanoparticles formed dispersed throughout the inner layers of raw naturally colored cotton fiber, raw sticky cotton, and raw ramie fibers treated with a silver nitrate solution in DI water. Silver nanoparticles formed embedded throughout the inner layers of raw white cotton, raw naturally colored cotton, raw sticky white cotton, and scoured and bleached white cotton treated with a silver nitrate solution in tap water. Silver nanoparticles formed embedded throughout the inner layers of raw white cotton, raw naturally colored cotton, raw sticky white cotton, and scoured and bleached white cotton fibers treated with silver nitrate and ammonium hydroxide in either DI or tap water. Silver nanoparticles formed embedded throughout the inner layers of raw white cotton, raw naturally colored cotton, raw sticky white cotton, and scoured and bleached white cotton treated with silver nitrate, ammonium hydroxide, and sodium hydroxide in DI water. Silver nanoparticles formed embedded throughout the inner layers of raw white cotton, raw naturally colored cotton, raw sticky white cotton, and scoured and bleached white cotton fiber treated with silver nitrate and sodium hydroxide in tap water. Silver nanoparticles formed evenly embedded in all fibers swollen by immersion in 20 wt % sodium hydroxide, followed by treatment with silver nitrate and ammonium hydroxide.

Fiber cross-sections were observed using techniques developed at the Southern Regional Research Center (Boylston, E. et al., 1991, “A quick embedding method for light and electron microscopy of textile fibers,” Biotech. Histochem. 66 (3): 122-124; and Thibodeaux, D. P. and Evans, J. P., 1986, “Cotton fiber maturity by image analysis,” Text. Res. J. 56: 130-139). Briefly, a bundle of combed fibers (ca. 15 mg) was immersed in a methacrylate matrix solution, and the matrix was polymerized in a Teflon tubing (3.2 mm inner diameter) under UV light for about 30 minutes. After removing the block of fiber bundle from the tubing, the block was re-embedded in BEEM embedding capsules. The fibers were sliced into sections of about 100 nm thickness using a PowerTome Ultramicrotome (Boeckeler Instruments Inc., Tucson, Ariz., USA). These fiber sections were placed on a carbon-film-coated copper grid and observed with a JEOL 2010 transmission electron microscope (JEOL, Peabody, Mass., USA).

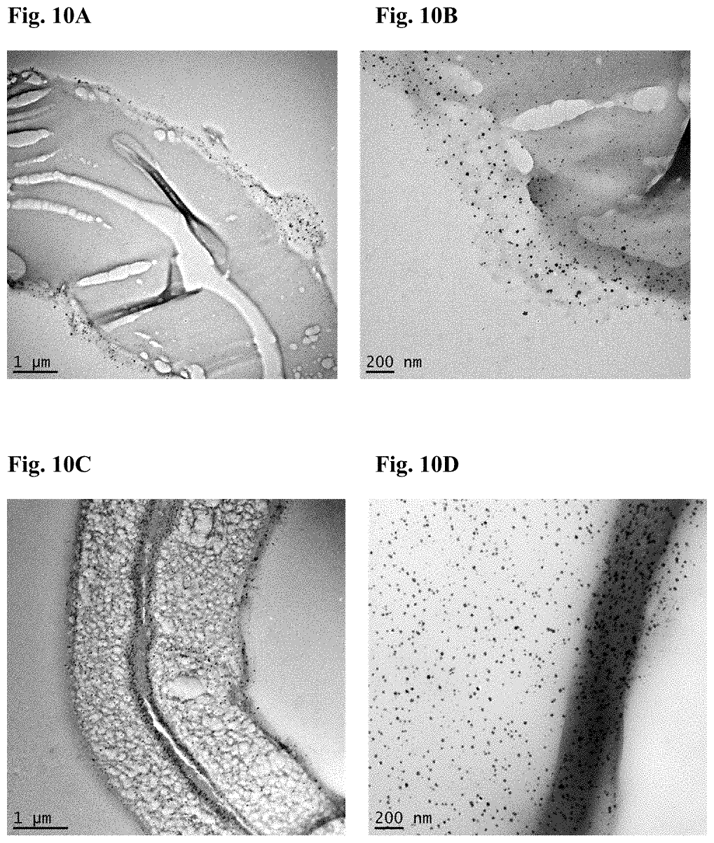

The distribution of the silver nanoparticles on treated fibers was performed using transmission electron microscope (TEM) of cross sections of treated fibers. The distribution of silver nanoparticles in the raw cotton fibers treated using a silver nitrate solution in DI water at 100° C. for 2 hours were analyzed (treated as in Example 1). As seen on FIG. 10A and FIG. 10B, silver nanoparticles formed concentrated mostly in the outer layers (the cuticle and primary wall) of raw white cotton fibers. As seen on FIG. 10C and FIG. 10D, silver nanoparticles formed dispersed throughout the treated raw naturally brown cotton fibers. A higher concentration of silver nanoparticles was observed in these treated brown cotton fibers near the lumen area.

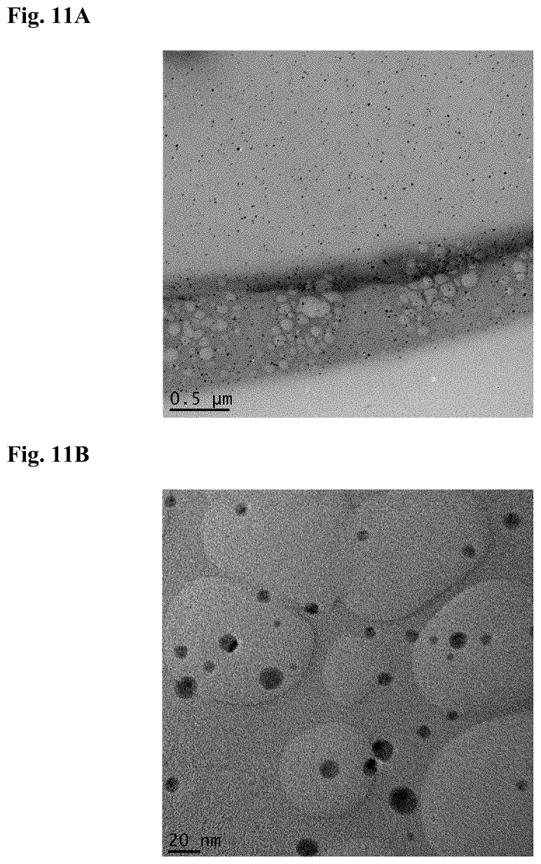

TEM images of cross-sections of cross-sections of sodium hydroxide-swollen raw white cotton fiber from the lightly needle-punched nonwoven fabric treated with silver nitrate and ammonium hydroxide at room temperature (treated as in Example 6), confirmed the internal formation of silver nanoparticles. A TEM image taken at the edge of the fiber is shown in FIG. 11A, and a TEM image taken at the center of the fiber is shown in FIG. 11B. These images were taken at different magnifications, and showed that a large number of silver nanoparticles were formed uniformly dispersed throughout the entire volume of the treated cotton fiber. The particles appeared spherical-like, and their size was 9.7±3.2 nm with a narrow size distribution.

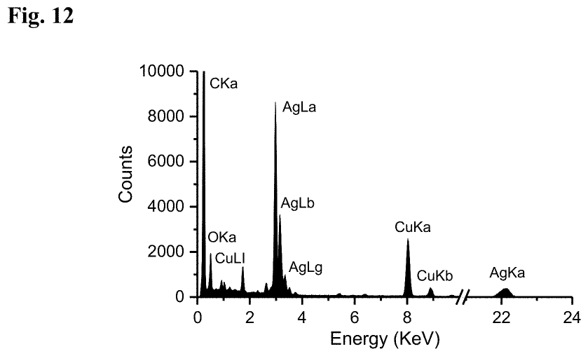

The embedded silver nanoparticles on cross-sections of treated fibers were also analyzed using selected area electron diffraction (SAED) and energy dispersive spectroscopy (EDS) using a transmission electron microscope JEOL 2010 operating at 200 kV. The image of an EDS spectrum is shown in FIG. 12. This image confirms the presence of silver characteristic peaks in cotton fiber treated with silver nitrate in DI water at 100° C. for 2 hours. The SAED pattern showed concentric rings with intermediate bright dots, which were attributed to the diffraction from the (1 1 1), (2 0 0), (2 2 0), and (3 1 1) planes of the face-centered cubic structure of elemental silver. These results confirm the formation of elemental silver nanoparticles inside treated cellulosic fibers. It is envisioned that any cellulosic fiber treated by the methods taught here will form silver nanoparticles throughout the outer layers and inner layers of the treated fiber.

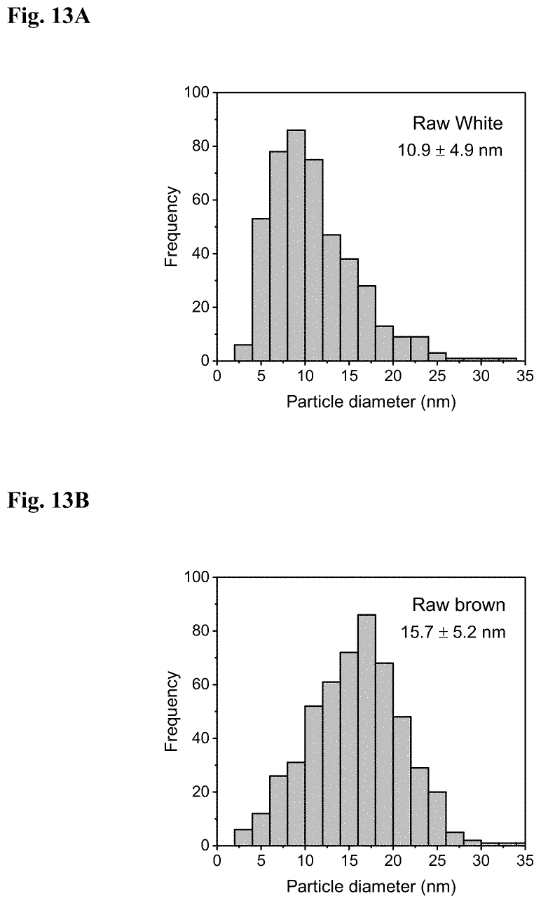

The particle size distribution of the nearly spherical silver nanoparticles generated in the raw cotton fibers treated using a 5 mM silver nitrate solution in DI water at 100° C. for 2 hours (treated as in Example 1) was analyzed. As seen in FIG. 13A, the silver nanoparticles in these treated raw white cotton fibers appeared to have a skewed distribution with an average size of about 10.9±4.9 nm. As seen in FIG. 13B, the silver nanoparticles in these treated raw naturally brown cotton fibers appeared to have a symmetrical distribution with an average size of about 15.7±5.2 nm.

### Example 8

### Wash Stability of Embedded Silver Nanoparticles

To determine the wash stability of silver nanoparticles formed by the methods described herein, needle-punched and hydroentangled nonwoven fabrics were prepared with fibers comprising embedded silver nanoparticles prepared as above. The percentage of surface plasmon resonance intensity remaining in the fibers after laundering was calculated. The percentage of surface plasmon resonance intensity is correlated to the amount of silver nanoparticles remaining in the fibers, was calculated using UV/Vis spectroscopy. The percentage of total silver remaining in the fibers was calculated using ICP-MS. As indicated by ICP-MS and UV/Vis spectroscopy, the majority of the silver and silver nanoparticles remained in the treated cotton fibers even after 50 laundering cycles.

To fabricate needle-punched and hydroentangled nonwoven fabrics, approximately 30 g of fibers were carded on a laboratory card (John D. Hollingsworth on Wheels, Inc., Greenville, S.C., USA) to produce a fiber web. The carded web was needle-punched with 490 strokes/min and then hydroentangled with a water jet pressure of 9 MPa for fiber bonding. The card web was hydroentangled on a Fleissner hydroentanglement system (Trützschler Nonwovens GmbH, Dülmen, Germany) in which each strip on the pressure heads consists of 16 orifices per centimeter with an orifice pore size of 120 μm. The production rate was 5 m/min, and water jet pressures were 2.5 MPa for pre-wetting and 9 MPa for fiber bonding. The fabrics were then transferred to the drying oven (Trützschler Nonwovens GmbH) at 170° C. and wound into a roll. The area density of the resulting nonwoven fabric was 100±5 g/m².

The washing durability test used was based on the AATCC Test Method 61-2007: Colorfastness to Laundering: Accelerated. Washing durability tests were performed using a Launder-Ometer laboratory washing machine (M228-AA; SDL Atlas USA, Rock Hill, S.C., USA). A rectangular fabric specimen (50×100 mm) was put into a stainless steel canister containing 200 ml of TIDE® (detergent for laundry, household, and institutional use; Procter & Gamble Co., Cincinnati, Ohio, USA) solution (0.37 wt % of total volume in DI water). Ten stainless steel balls (6.35 mm in diameter) were added to the steel cannister to simulate friction during laundering. The canisters were preheated to 40±1° C., followed by rotation at a constant temperature of 40±1° C. with a constant rate of 40±2 rpm for 45 minutes. This accelerated laundering procedure is equivalent to five home or commercial laundering cycles. After laundering, the specimen was rinsed in water for 5 minutes and air-dried.

The silver concentration in treated cotton fabrics was determined using an inductively coupled plasma mass spectroscope (ICP-MS) (Agilent 7500ce ICP-MS; Agilent Technologies; Santa Clara, Calif., USA). Approximately 0.05 g of the sample was treated with 2 ml of 16 M nitric acid (Trace Metal Grade) and digested in a Milestone Ethos Microwave System. These digests were diluted by weight 1:10, and ten parts per billion (ppb) of indium (In) was added as an internal standard. The resulting solution was analyzed with an external calibration curve with 0, 0.1, 0.5, 1, 5, 20, and 50 ppm prepared from 1,000 ppm Ag single element standard (Inorganic Ventures; Christiansburg, Va., USA) using ICP-MS with syringe-FAST (all PTFE, ESI, Omaha, Nebr., USA) introduction system, double-pass quartz spray chamber, PTFE nebulizer, sapphire injector and platinum cones. The surface plasmon resonance absorption intensity, which is correlated with the amount of silver nanoparticles on treated cotton fibers, was measured using a UV/Vis spectrometer (ISR-2600, Shimadzu).

When using ICP-MS to measure the amount of silver in cotton fabrics treated with a 5 mM silver nitrate solution in DI water at 100° C. for 2 hours, treated raw naturally brown cotton fabrics had about 10,567 mg/kg, and treated raw white cotton fabrics had approximately 34 times less, about 314 mg/kg. In all cases, when measured using a UV/Vis spectrometer the percentage of surface plasmon resonance absorption intensity remaining on the treated fabrics after laundering appeared to be greater than the percentage of silver remaining in the treated fabrics when measured using ICP-MS.

After 50 laundering cycles, at least about 74% of the total silver and at least about 83% of the surface plasmon resonance intensity remained in raw white cotton fabrics treated with silver nitrate in DI water at 100° C. for 2 hours. After 50 laundering cycles, at least about 85% of the total silver and at least about 97% of the surface plasmon resonance intensity remained in raw naturally brown cotton fabrics treated with silver nitrate in DI water at 100° C. for 2 hours.

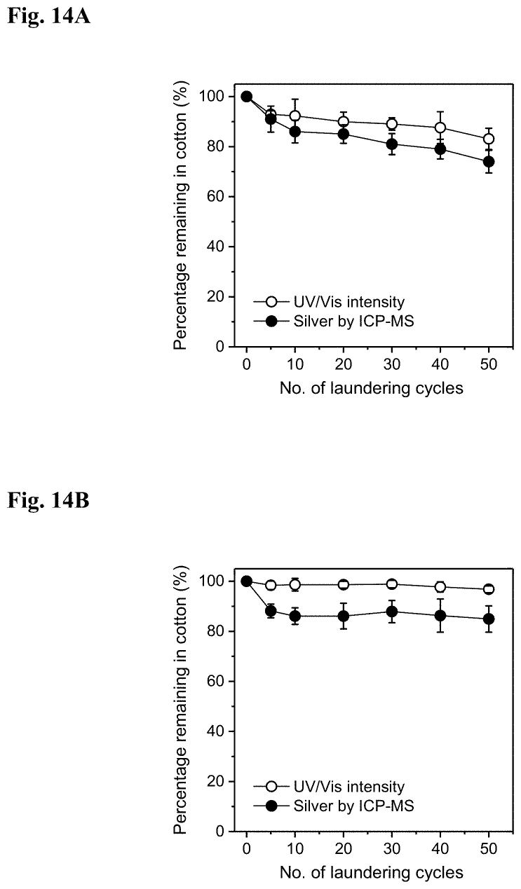

The percentage of total silver and surface plasmon resonance absorption intensity remaining after laundering raw fabrics treated with a 5 mM silver nitrate solution in DI water at 100° C. for 2 hours were measured. As the number of laundering cycles increased, the rates of total silver loss and surface plasmon resonance absorption intensity loss decreased. FIG. 14A shows the results for treated raw white cotton fiber. When measured by ICP-MS, as the number of laundering cycles increased, the rate of silver loss increased linearly up to 10 cycles, and above 10 laundering cycles the rate of silver loss decreased. When measured using UV/Vis intensity, the rate of surface plasmon resonance absorption intensity loss decreased after 5 laundering cycles. FIG. 14B shows the results for treated brown cotton fiber. When measured by ICP-MS, the rate of silver loss increased rapidly up to 5 cycles, and above 5 laundering cycles the rate of silver loss greatly decreased. When measured using UV/Vis intensity, the rate of surface plasmon resonance absorption intensity loss did not significantly change over 50 laundering cycles.

FIG. 14A shows that for raw white cotton treated with 5 mM silver nitrate solution in DI water at 100° C. for 2 hours about 91% of total silver remained after 5 laundering cycles; about 86% of total silver remained after 10 laundering cycles; about 85% of total silver remained after 20 laundering cycles; about 83% of total silver remained after 30 laundering cycles; about 79% of total silver remained after 40 laundering cycles; and about 75% of total silver remained after 50 laundering cycles. Surface plasmon resonance absorption intensity, which is correlated with the amount of silver nanoparticles on the fabric, showed that treated raw white cotton retained about 93% of the intensity after 5 laundering cycles; retained about 92% of the intensity after 10 laundering cycles; retained about 90% of the intensity after 20 laundering cycles; retained about 89.5% of the intensity after 30 laundering cycles; retained about 88% of the intensity after 40 laundering cycles; and retained about 84% of the intensity after 50 laundering cycles.

FIG. 14A shows that for raw naturally colored cotton treated with 5 mM silver nitrate solution in DI water at 100° C. for 2 hours about 88% of total silver remained after 5 laundering cycles; about 86% of total silver remained after 10 laundering cycles; about 86% of total silver remained after 20 laundering cycles; about 87% of total silver remained after 30 laundering cycles; about 86% of total silver remained after 40 laundering cycles; and about 85% of total silver remained after 50 laundering cycles. Surface plasmon resonance absorption intensity, which is correlated with the amount of silver nanoparticles on the fabric, showed that treated raw naturally colored cotton retained about 98% of the intensity after 5, 10, 20, or 30 laundering cycles; retained about 97% of the intensity after 40 laundering cycles; and retained about 96% of the intensity after 50 laundering cycles.

These results indicate that even after prolonged laundering procedures a majority of silver nanoparticles are retained in the raw cotton fibers treated with a 5 mM silver nitrate in DI water at 100° C. for 2 hours. Particularly, the silver nanoparticles formed in raw naturally brown cotton appeared to be more leach-resistant than the silver nanoparticles formed in raw white cotton. Similarly, the surface plasmon resonance absorption intensity, which is correlated with the amount of silver nanoparticles on the fabric, showed that a majority of silver nanoparticles are retained in the raw cotton fibers treated with a 5 mM silver nitrate in DI water at 100° C. for 2 hours even after prolonged laundering procedures. Particularly, the silver nanoparticles formed in raw naturally brown cotton appeared to be more leach-resistant than the silver nanoparticles formed in raw white cotton.

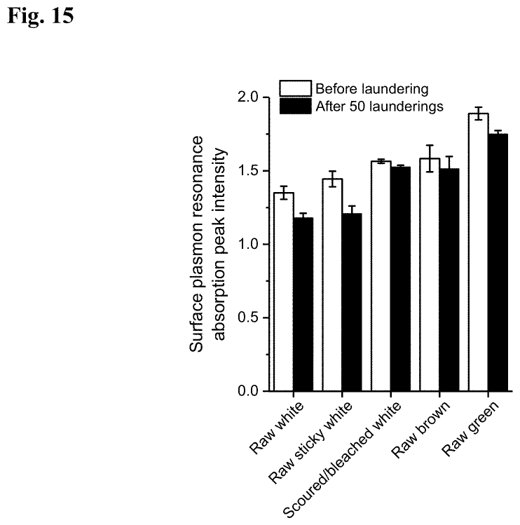

The surface plasmon resonance peak intensities on cotton fibers treated with 5 mM silver nitrate, 15 mM ammonium hydroxide in DI water at 100° C. for 0.25 hours were measured before laundering and after 50 laundering cycles. As seen in FIG. 15, after 50 laundering cycles, at least about 87% of the surface plasmon resonance absorption intensity remained in treated raw white cotton fiber; at least about 84% of the surface plasmon resonance absorption intensity remained in treated raw sticky white cotton fiber; at least about 98% of the surface plasmon resonance absorption intensity remained in treated scoured and bleached white cotton fiber; at least about 96% of the surface plasmon resonance absorption intensity remained in treated raw naturally brown cotton fiber; and at least about 93% of the surface plasmon resonance absorption intensity remained in treated raw naturally green cotton. These data suggest that treatment of raw white cotton, raw sticky white cotton, raw naturally green cotton, raw naturally brown cotton, or scoured and bleached white cotton with 5 mM silver nitrate, 15 mM ammonium hydroxide in DI water at 100° C. for 0.25 hours produced leach-resistant silver nanoparticles embedded in the both raw cottons and the scoured and bleached cotton.

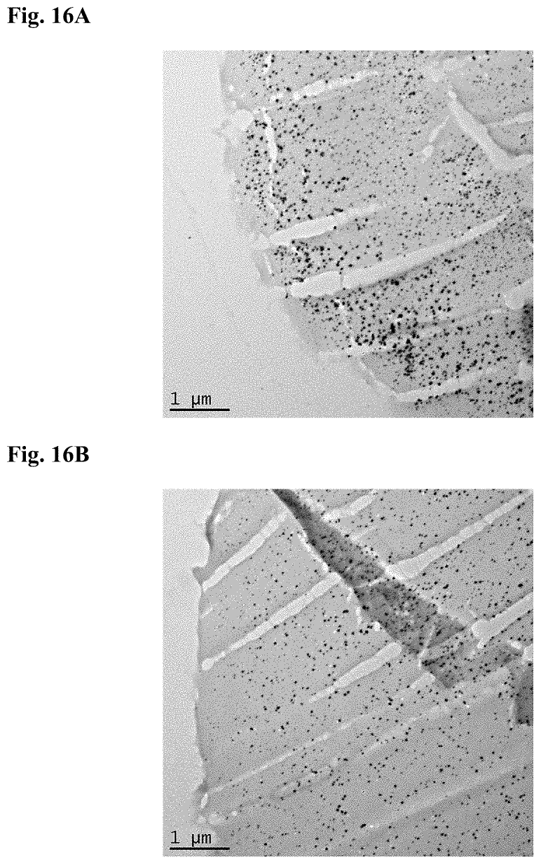

Cross-sections of scoured and bleached white cotton fiber treated with 5 mM silver nitrate, 15 mM ammonium hydroxide in DI water at 100° C. for 0.25 hours were obtained before laundering or after 50 laundering cycles and were observed under the microscope. As seen on the photomicrograph shown in FIG. 16A, a large number of silver nanoparticles appeared embedded inside the treated scoured and bleached white cotton fiber. The photomicrograph on FIG. 16B shows that after 50 laundering cycles the majority of the silver nanoparticles remained inside the treated scoured and bleached white cotton fiber.

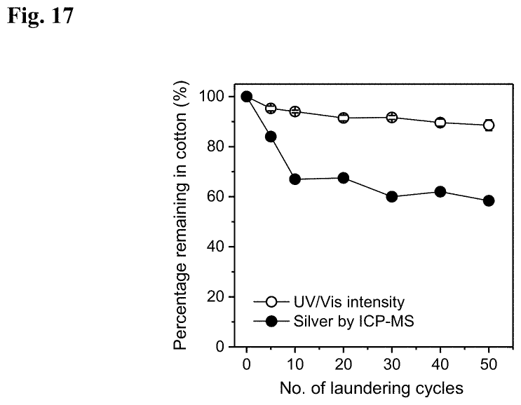

The percentage of total silver remaining, and the surface plasmon resonance absorption intensity remaining in cotton fabrics treated with 1.76 mM silver nitrate, 39.3 mM ammonium hydroxide, 2.1 wt % sodium hydroxide, 0.05 wt % TRITON X-100 at room temperature for 16 hours, after various numbers of laundering cycles are shown in FIG. 17. This figure shows that as the number of laundering cycles increased, the rates of total silver loss and surface plasmon resonance absorption intensity loss decreased. When measured by ICP-MS, as the number of laundering cycles increased, the rate of total silver loss increased linearly up to 10 cycles, and above 10 laundering cycles the rate of silver loss decreased. When measured using a UV/Vis spectrometer, the rate of surface plasmon resonance absorption intensity loss was lower. When measured by ICP-MS, the percentage of total silver remaining in the treated cotton fabric was about 82% after 5 laundering cycles; about 64% after 10 or 20 laundering cycles; about 60% after 30 laundering cycles; about 61% after 40 laundering cycles; and about 59% after 50 laundering cycles. The treated cotton retained about 97% surface plasmon resonance absorption intensity after 5 or 10 laundering cycles; and about 95% after 20, 30, 40, or 50 laundering cycles. These results indicate that, even after prolonged laundering procedures, the majority of silver nanoparticles were retained in cotton fibers treated with 1.76 mM silver nitrate, 39.3 mM ammonium hydroxide 2.1 wt % sodium hydroxide, 0.05 wt % TRITON X-100 at room temperature for 16 hours.

The stability of silver nanoparticles in non-disposable textile products (those which require routine laundering) prepared with at least one fiber treated by the method of Example 6 was analyzed. Nonwoven fabrics containing either 1% or 2% cotton treated following the method of Example 6 were prepared and subjected to up to 50 laundering cycles. The percentage of surface plasmon resonance absorption intensity remaining on the cotton were measured using a UV/Vis spectrometer as a function of laundering cycles. The concentration of total silver in the fabric was measured using ICP-MS as a function of laundering cycles.

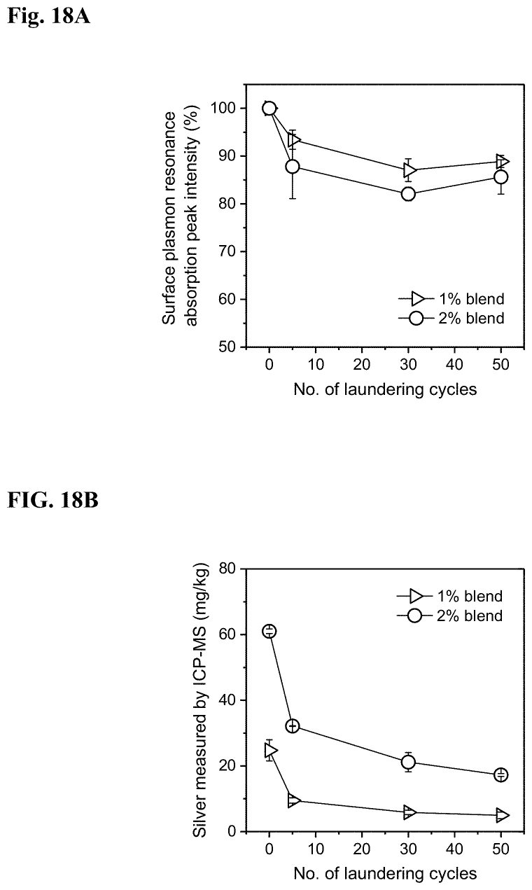

As seen in FIG. 18A and FIG. 18B, the percentage of surface plasmon resonance absorption intensity and the concentration of total silver remaining in the textile dropped rapidly during the first 5 laundering cycles. This initial decrease in surface plasmon resonance absorption intensity and total silver were attributed to the loss of the silver nanoparticles formed on the surface of fibers. After 5 laundering cycles, the extent of the decrease was greatly suppressed, reflecting that the remaining silver nanoparticles were anchored inside the fiber. The surface plasmon absorption intensity loss was greater for the textile comprising 2% fiber with embedded silver nanoparticles than for the textile comprising 1% fiber with embedded silver nanoparticles. As expected, the textile comprising 1% fiber with embedded silver nanoparticles had less silver nanoparticles than the textile comprising 2% fiber with embedded silver nanoparticles. But, the rate of loss was similar for both.

### Example 9

### Silver Nanoparticle Stability to Scouring and Bleaching

To determine the stability of silver nanoparticles formed embedded raw cotton fabrics, to the scouring and bleaching process, raw white cotton fiber treated with 5 mM silver nitrate, 0.05 wt % TRITON X-100 in tap water at 100° C. for 0.25 hours was scoured and bleached. After scouring and bleaching, the treated raw cotton fiber retained most of the silver nanoparticles.

Raw cotton fiber treated with silver nitrate in DI water at 100° C. for 2 hours were scoured and bleached. Alkaline scouring was carried out using an overflow-jet dyeing apparatus (Werner Mathis AG; Oberhasli, Switzerland). The treated raw cotton fabrics were circulated in an aqueous solution containing 1.7 g/L NaOH and 0.2 g/L TRITON X-100 with a liquid-to-fabric ratio of 30:1 at 100° C. for 1.5 hours. After rinsing the scoured fabrics at room temperature, bleaching was carried out using the overflow-jet dyeing apparatus. The scoured fabrics were circulated in an aqueous solution containing 1.0 g/L NaOH, 1.0 g/L sodium silicate 42 Be, 5.0 g/L hydrogen peroxide (H₂O₂), 1.0 g/L Na₂CO₃, and 0.2 g/L TRITON X-100 with a liquid-to-fabric ratio of 30:1 at 100° C. for 1.5 hours. The scoured and bleached fabrics were rinsed for 20 minutes at room temperature three times. The fabrics were then neutralized with an aqueous solution of 0.25 g/L acetic acid for 10 minutes, rinsed with water, and air-dried.

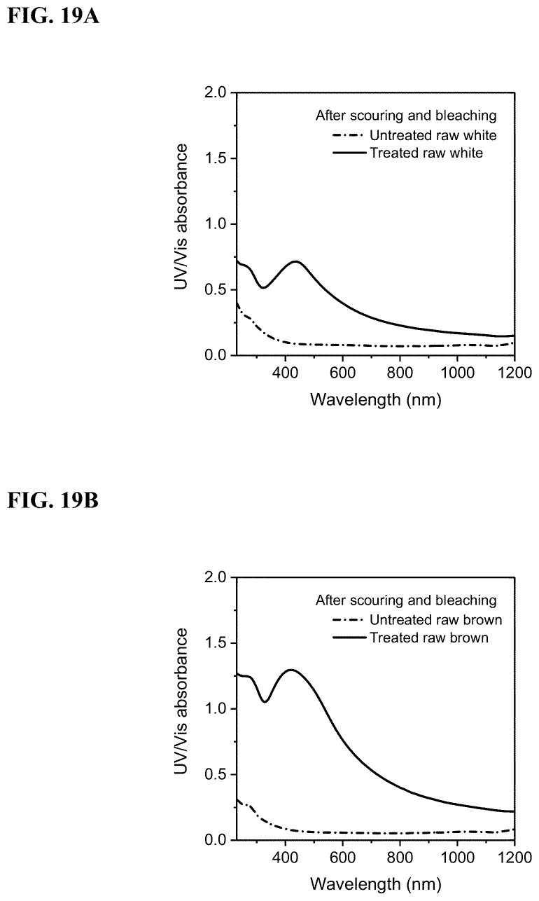

UV/Vis spectra for treated and untreated raw white cotton scoured and bleached as above is shown in FIG. 19A. UV/Vis spectra for treated and untreated raw naturally brown cotton scoured and bleached as above is shown in FIG. 19B. As scouring and bleaching removed almost all non-cellulosic components, including natural pigment present in raw cottons, scoured and bleached untreated raw white and untreated raw naturally brown cotton became equally white as indicated by their similar UV/Vis spectra, as shown by the dash dot lines in FIG. 19A and FIG. 19B. After scouring and bleaching raw white cotton and raw naturally brown cotton treated with silver nitrate in DI water at 100° C. for 2 hours exhibited a surface plasmon resonance absorption peak, as shown by the solid lines in FIG. 19A and FIG. 19B. When compared with the surface plasmon resonance absorption peak intensities seen in FIG. 1A and FIG. 1B, the percentage of surface plasmon resonance absorption peak intensity remaining after scouring and bleaching was about 74% for treated raw white cotton, and was about 85% for treated raw naturally brown cotton.

### Example 10

### Antibacterial Properties

Fabrics prepared with treated cotton fibers maintained antibacterial properties against Gram-positive and Gram-negative bacteria even after 50 laundering cycles.

Antibacterial properties of nonwoven fabrics prepared with treated cotton against Gram-positive Staphylococcus aureus ATCC 6538 (S. aureus) and Gram-negative Pseudomonas aeruginosa ATCC 15442 (P. aeruginosa) were examined. Testing was conducted by Microchem Laboratory (Round Rock, Tex., USA) using the AATCC test method 100-2004: “Antibacterial Finishes on Textile Materials: Assessment of”. For each sample, 1.0±0.1 ml of inoculum with an approximate bacterial density of 3×10⁵ CFU/carrier was placed onto four circular swatches (4.8±0.1 cm in diameter) of a nonwoven fabric. After incubating the swatches at 37±2° C. for 24 hours (contact time), bacterial population density was assayed to obtain a percent reduction of bacteria using the following equation:

$$Percent reduction ( \% ) = ( \frac{B - A}{B} ) \times 100$$

where A is the number of viable test bacteria on the control sample immediately after inoculation, and B is the number of viable test bacteria on the test sample after the contact time.

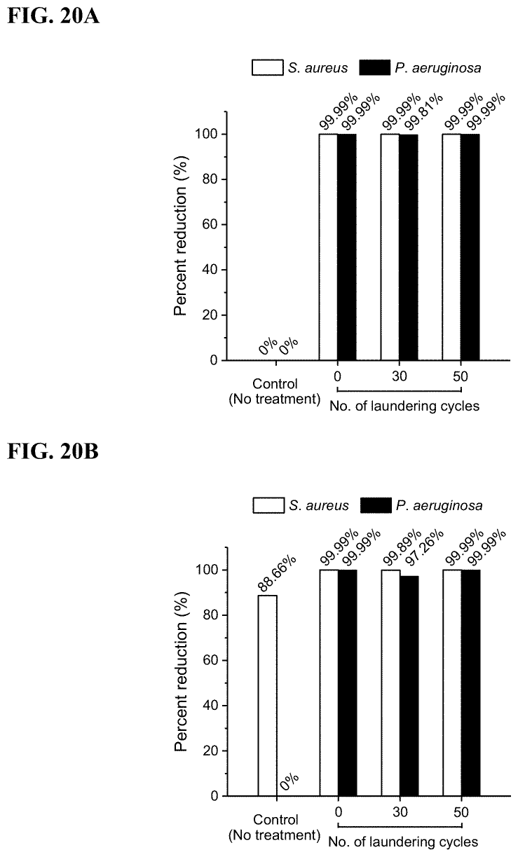

The effect on the bacterial reduction capacity of control raw cotton and raw cotton treated with 5 mM silver nitrate, 0.05 wt % TRITON X-100 in DI water at 100 C for two hours was analyzed after different numbers of laundering cycles. As seen in FIG. 20A, control raw white cotton (no silver treatment) did not inhibit bacterial growth, and treated raw white cotton exhibited over 99.99% reduction in the number of viable Gram-positive and Gram-negative bacteria before laundering, after 30 laundering cycles, and after 50 laundering cycles. As seen in FIG. 20B, control raw naturally brown cotton (no silver treatment) exhibited S. aureus growth inhibition, but had no effect on P. aeruginosa growth; and treated raw naturally brown cotton showed over 99.99% reduction in the number of viable Gram-positive and Gram-negative bacteria before laundering, after 30 laundering cycles, and after 50 laundering cycles.

### Example 11

### Bacterial Inhibition of Blended Textile Products

A blend of at least 0.2 wt % fibers treated as in example 6 with pristine scoured and bleached white cotton is sufficient to reduce bacterial viability.

Treated cotton fiber was blended with pristine scoured/bleached cotton fiber at various weight percentages and fabricated into a hydroentangled nonwoven fabric. Approximately 15 g of fibers were uniformly blended and carded on a laboratory card (John D. Hollingsworth on Wheels, Inc., Greenville, S.C.) to produce a fiber web. The card web was hydroentangled on a Fleissner hydroentanglement system (Trützschler Nonwovens GmbH, Dülmen, Germany), in which each strip on the pressure heads consists of 16 orifices per centimeter with an orifice pore size of 120 μm. The production rate was 5 m/min, and water jet pressures were 2.5 MPa for pre-wetting and 5 MPa for fiber bonding. The fabrics were then transferred to the drying oven (Trützschler Nonwovens GmbH) at 170° C. and wound into a roll. The density of the nonwoven fabric was 30±5 g/m².

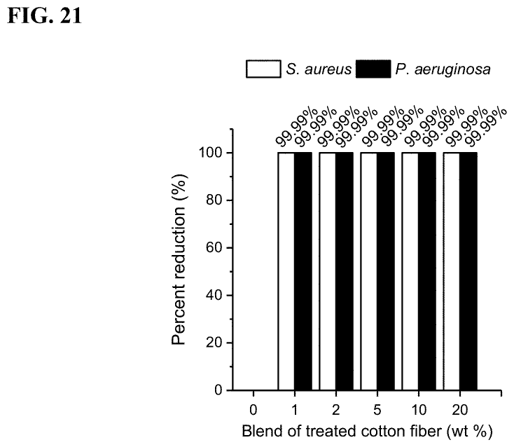

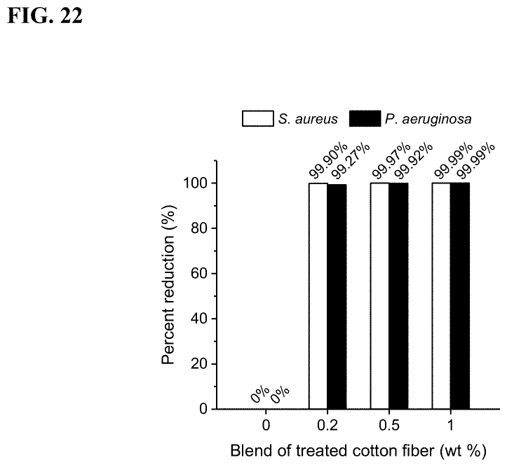

As seen in FIG. 21, all nonwoven fabrics prepared with 1 wt % to 20 wt % fiber treated as in Example 6 exhibited above 99.99% reduction of both, Gram-positive and Gram-negative bacteria. As seen in FIG. 22, all nonwoven fabrics prepared with 0.2 wt %, 0.5 wt %, or 1 wt % fiber treated as in Example 6 exhibited above 99.99% reduction of both, Gram-positive and Gram-negative bacteria.

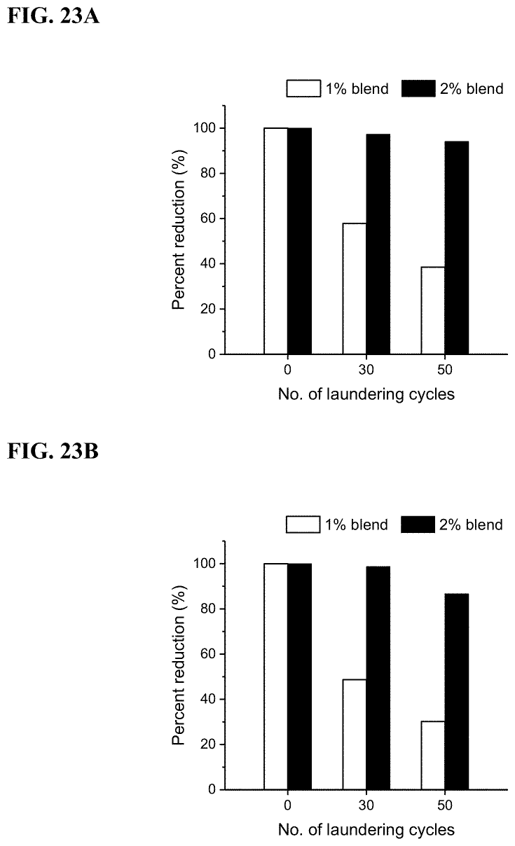

The antibacterial properties of nonwoven fabrics containing 1 wt % and 2 wt % of cotton fibers treated as in Example 6 were analyzed after multiple laundering cycles and the results are shown in FIG. 23A against Gram-positive bacteria and FIG. 23B against Gram-negative bacteria. For nonwoven fabrics containing 1% treated fiber, the percent reduction of Gram-positive and Gram-negative bacteria decreased as the number of laundering cycles increased. After 50 laundering cycles nonwoven fabric containing 2 wt % treated fiber exhibited 94% reduction of Gram-positive bacteria, and 87% reduction of Gram-negative bacteria. These results suggest that fabrics comprising at least 2 wt % of treated cotton fiber are useful for the preparation of wash-durable antibacterial textile products.

The foregoing detailed description and certain representative embodiments and details of the invention have been presented for purposes of illustration and description of the invention. It is not intended to be exhaustive or to limit the invention to the precise forms disclosed. It will be apparent to practitioners skilled in the art that modifications and variations may be made therein without departing from the scope of the invention.

All publications, patents, and patent applications mentioned in this specification are herein incorporated by reference to the same extent as if each individual publication, patent, or patent application was specifically and individually indicated to be incorporated by reference.

We claim:

1. A treated cellulosic fiber comprising embedded silver nanoparticles, wherein the cellulosic fiber treated is not a swollen cellulosic fiber.

2. The treated cellulosic fiber of claim 1, wherein the cellulosic fiber treated is selected from the group consisting of white cotton, sticky white cotton, naturally colored cotton, scoured and bleached cotton, flax, hemp, jute, ramie, pineapple leaf, and abaca.

3. The treated cellulosic fiber of claim 1, wherein:
the cellulosic fiber treated is raw white cotton fiber, and the silver nanoparticles are embedded on the cuticle and primary wall of the treated fiber; or
the cellulosic fiber treated is selected from the group consisting of ramie, white cotton fiber, sticky fiber, naturally colored cotton fiber, and scoured and bleached cotton fiber, and the silver nanoparticles are embedded throughout the inner layers of the treated fiber.

4. The treated cellulosic fiber of claim 1, wherein at least about 50% of the silver nanoparticles remain embedded in the treated cellulosic fiber after at least about 10, 20, 30, 40, or 50 laundering cycles.

5. An article comprising at least one treated cellulosic fiber of claim 1.

6. The article of claim 5, wherein the article is selected from the group consisting of a yarn, a thread, a twine, a rope, a cloth, a woven fabric, a knitted fabric, a film-based composite, a nonwoven fabric, and a final article.

7. Athletic wear, an undergarment, military wear, a medical textile, a washable sanitizing wipe, a disposable sanitizing wipe, a film-based fiber-containing composite, a functional barrier, a towel, a bedding, a shoe liner, a garment liner, or a curtain comprising at least one treated cellulosic fiber of claim 1.

8. The medical textile of claim 7, wherein the medical textile is selected from the group consisting of a curtain, a bedding, a surgical arena fabric, a surgical personnel protective garment, and a wound or non-wound patient dressing, a bandage, a gauze, a packing, or a cleaning material.

9. The article of claim 5, wherein the article is antimicrobial, antibacterial, anti-odor, antiviral, or anti-fungal.

10. A method for preparing the treated cellulosic fiber of claim 1, wherein the method comprises:
immersing cellulosic fiber in a silver ion precursor solution; and
maintaining the immersed fiber in the solution at a set temperature;
wherein the silver ion precursor is selected from the group consisting of silver nitrate, silver sulfate, and silver perchlorate, and is present at a set concentration in water;
wherein the solution optionally comprises at least one of a wetting agent, an ammonium source, and an alkali source; and
wherein the method does not require adding a stabilizing agent, or adding a reducing agent.

11. The method of claim 10, wherein the cellulosic fiber is selected from the group consisting of scoured and bleached cotton, raw white cotton, naturally colored cotton, sticky cotton, flax, hemp, jute, ramie, pineapple leaf, and abaca.

12. The method of claim 11, wherein the physical form of the cellulosic fiber is selected from a fiber, a yarn, a package, a fabric, a thread, a twine, a rope, a cloth, a woven fabric, a knitted fabric, a film-based composite, and a nonwoven fabric.

13. The method of claim 10, wherein the solution further comprises about 0.02 wt % to about 0.1 wt % of a wetting agent selected from the group consisting of octyl phenol ethoxylate, polysorbate 20, polysorbate 60, polysorbate 80, polyethylene glycol, glycerin, thiodiglycol, diethylene glycol, urea, thiourea, dicyandiamide, and 4-(1,1,3,3-tetramethylbutyl)phenyl-polyethylene glycol).

14. The method of claim 13, wherein the silver ion precursor is silver nitrate, the silver nitrate concentration is from about 0.001 mM to about 1 M, the set temperature is from about 80° C. to about 100° C.; the water is deionized (DI) water; and wherein:
the cellulosic fiber is raw white cotton fiber, and the silver nanoparticles are formed embedded mostly on the cuticle and primary wall of the treated cellulosic fiber; or
the cellulosic fiber is selected from the group consisting of naturally colored cotton, sticky cotton, flax, hemp, jute, ramie, pineapple leaf, and abaca; and
wherein the silver nanoparticles are formed embedded throughout the treated cellulosic fiber.

15. A treated cellulosic fiber comprising embedded silver nanoparticles prepared by the method of claim 14.

16. The method of claim 13, wherein the silver ion precursor concentration is from about 0.001 mM to about 1 M; the set temperature is about 80° C. to about 100° C.; the water is tap water; and
wherein the silver nanoparticles are formed embedded throughout the fiber.

17. A treated cellulosic fiber comprising embedded silver nanoparticles prepared by the method of claim 16.

18. The method of claim 13, wherein the solution further comprises an ammonium source selected from ammonia, and an ammonium salt selected from the group comprising of hydroxide, fluoride, chloride, bromide, iodide, acetate, carbonate, carbamate, nitrite, nitrate, hydrogen sulfate, sulfate, thiosulfate, trifluoromethanesulfonate, tetrafluoroborate, perchlorate, chlorate, chlorite, dihydrogenphosphate, hydrogen phosphate, phosphate, and phosphite.

19. The method of claim 18, wherein the silver ion precursor concentration is from about 0.001 mM to about 1 M; the ammonium source is present from about 0.003 mM to about 3 M; the water is DI water or tap water; the temperature is about 100° C.; and
wherein the silver nanoparticles are formed embedded throughout the fiber.

20. A treated cellulosic fiber comprising embedded silver nanoparticles prepared by the method of claim 19.

21. The method of claim 18, wherein the solution further comprises an alkali source selected from the group consisting of sodium hydroxide, sodium carbamate, sodium carbonate, lithium hydroxide, lithium carbamate, lithium carbonate, potassium hydroxide, potassium carbamate, potassium carbonate, rubidium hydroxide, rubidium carbamate, rubidium carbonate, cesium hydroxide, cesium carbamate, cesium carbonate, beryllium hydroxide, beryllium carbamate, beryllium carbonate, magnesium hydroxide, magnesium carbamate, magnesium carbonate, calcium hydroxide, calcium carbamate, and calcium carbonate.

22. The method of claim 21, wherein the silver ion precursor concentration is from about 0.001 mm to about 1 M; the ammonium source is present from about 0.022 mM to about 22 M;
the alkali source is present from about 0.0012 wt % to about 50 wt %; the water is DI water;
the temperature is from about 20° C. to about 100° C.; and
wherein the silver nanoparticles are formed embedded throughout the fiber.

23. A treated cellulosic fiber comprising embedded silver nanoparticles prepared by the method of claim 22.

24. The method of claim 21, wherein the silver ion precursor concentration is from about 0.001 mm to about 1 M; the ammonium source is present from about 0.022 mM to about 22 M;
the alkali source is present from about 0.0012 wt % to about 50 wt %; the water is DI water;
the temperature is about 40° C. to about 100° C.; and
wherein the silver nanoparticles are formed embedded throughout the fiber.

25. A treated cellulosic fiber comprising embedded silver nanoparticles prepared by the method of claim 24.

26. The method of claim 10, wherein the solution further comprises an alkali source selected from the group consisting of sodium hydroxide, sodium carbamate, sodium carbonate, lithium hydroxide, lithium carbamate, lithium carbonate, potassium hydroxide, potassium carbamate, potassium carbonate, rubidium hydroxide, rubidium carbamate, rubidium carbonate, cesium hydroxide, cesium carbamate, cesium carbonate, beryllium hydroxide, beryllium carbamate, beryllium carbonate, magnesium hydroxide, magnesium carbamate, magnesium carbonate, calcium hydroxide, calcium carbamate, and calcium carbonate.

27. The method of claim 26, wherein the silver ion precursor concentration is from about 0.001 mM to about 1 M; the alkali source is present from about 0.0000057 wt % to about 50 wt %;
the water is tap water; the temperature is about 60° C. to about 100° C.; and
wherein the silver nanoparticles are formed embedded throughout the fiber.

28. A treated cellulosic fiber comprising embedded silver nanoparticles prepared by the method of claim 27.

29. A method for preparing a treated swollen cellulosic fiber comprising embedded silver nanoparticles, the method comprising:
immersing swollen cellulosic fiber in a solution comprising from about 0.001 mM to about 1 M silver ion precursor and from about 0.0033 mM to about 3.3 M ammonium source; in DI water; and
maintaining the immersed fiber in the solution at a set temperature from about 20° C. to about 100° C.;
wherein the method does not require adding a reducing agent or adding a stabilizing agent.

30. The method of claim 29, wherein prior to immersing the swollen cellulosic fiber in a solution comprising a silver ion precursor and an ammonium source, the cellulosic fiber is swollen by immersing in a high concentration alkaline solution.

31. The method of claim 29, wherein silver nanoparticles are formed embedded in at least about 90% of the swollen treated fibers.
